(19) United States
(12) Patent Application Publication
(10) Pub. No.: US 2010/0046339 A1
(43) Pub. Date: Feb. 25, 2010

(54) OPTICAL DISC RECORDING/REPRODUCTION APPARATUS

(76) Inventors: Yoshihiro Kanda, Osaka (JP); Mayumi Yasukouchi, Osaka (JP); Dai Ichiryu, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/441,987

(22) PCT Filed: Sep. 19, 2007
(86) PCT No.: PCT/JP2007/068117

§ 371 Date: Mar. 19, 2009

(30) Foreign Application Priority Data
Sep. 19, 2006 (JP) 2006-252059

(51) Int. Cl. G11B 20/00

(52) U.S. Cl. 369/47.15; G9B/20

(57) ABSTRACT

The present invention solves the problems that, in a detection circuit which is mostly configured by analog circuits, the chip size cannot be reduced even using a highly-precise processing, there are many external capacitors and terminals thereof, a plurality of high-speed and large-scale AD converters are required for digitization, the detection precision of a small amplitude signal superimposed on an RF signal is deteriorated, and high-speed sample/hold is required.

A significant deletion of analog circuits can be realized by generating a digital detection signal directly from an analog RF signal using a simple analog circuit configuration of a detection control means including a comparator, a threshold DAC for setting a threshold value, and an integrator.

### TECHNICAL FIELD

The present invention relates an improved optical disc recording/reproduction apparatus.

### BACKGROUND ART

In recent years, there has been a strong demand for cost reduction in an optical disc recording/reproduction apparatus, and a demand for cost reduction in electronic parts to be used such as LSIs has also been extremely increased. In order to meet these demands, technological development for reducing the number of parts by increasing the integration density of LSIs has been performed, and particularly, deletion of analog circuits which are obstacles to promoting high-density integration has been demanded.

Hereinafter, an RF signal detector in a conventional optical disc recording/reproduction apparatus will be described.

FIG. 9 is a block diagram of an RF signal detector according to an analog processing of a conventional optical disc recording/reproduction apparatus.

In FIG. 9, reference numeral 101 denotes a light-receiving element which is divided into four parts along the radial direction of an optical disc and the tangential direction of tracks formed on the optical disc, and reference numeral 102 denotes an amplifier comprising four IV conversion amplifiers which IV (current to voltage) convert the output signals from the four light receiving elements A, B, C and D into which the light receiving element 101 is divided. Reference numeral 103a denotes an adder for adding the four outputs from the amplifier 102 to each other to generate an RF signal, reference numeral 104a denotes an amplifier for adjusting the dynamic range of the RF signal outputted from the adder 103a, reference numeral 105a denotes a peak/bottom detector for detecting a peak level and a bottom level of the RF signal amplified by the amplifier 104a to generate an RF peak signal and an RF bottom signal, reference numeral 106a denotes a binarizer for binarizing the RF peak signal generated by the peak/bottom detector 105a with an appropriate threshold value to generate a dropout signal (BDO), and reference numeral 106b denotes a binarizer for binarizing the RF bottom signal generated by the peak/bottom detector 105a with an appropriate threshold value to generate an off-track signal (OFTR).

Further, reference numeral 104b denotes an amplifier which adjusts the dynamic range of the RF signal in a section corresponding to an ID region in the RF signal outputted from the adder 103a, reference numeral 105b denotes a peak/bottom detector which performs peak detection and bottom detection to the output of the amplifier 104b at the timing of a gate signal 1 (gate1) which becomes effective in a section of VFO1 which is the first half of the ID region in the output of the amplifier 104b, thereby to generate a VFO1 peak signal and a VFO1 bottom signal, reference numeral 105c denotes a peak/bottom detector which performs peak detection and bottom detection to the output of the amplifier 104b at the timing of a gate signal 2 (gate2) which becomes effective in a section of VFO3 which is the second half of the ID region in the output of the amplifier 104b, thereby to generate a VFO3 peak signal and a VFO3 bottom signal, and reference numeral 106c denotes a TCTI signal generator which generates a track center signal (TC) and a tilt signal (TI) from the VFO1 peak signal and the VFO1 bottom signal outputted from the peak/bottom detector 105b and the VFO3 peak signal and the VFO3 bottom signal outputted from the peak/bottom detector 105c.

Further, reference numeral 103b denotes an adder which calculates a sum of the signals obtained by amplifying the output signals from the two light receiving elements A and D placed on the inner circumference side of the optical disc to generate an inner circumference RF signal, reference numeral 103c denotes an adder which calculates a sum of the signals obtained by amplifying the output signals from the two light receiving elements B and C placed on the outer circumference side of the optical disc to generate an outer circumference RF signal, reference numeral 104c denotes an amplifier which adjusts the dynamic range of the output RF signal from the adder 103b, reference numeral 104d denotes an amplifier which adjusts the dynamic range of the output RF signal from the adder 103c, reference numeral 105c denotes a peak detector which performs peak detection for the inner circumference RF signal outputted from the amplifier 104c to generate an inner circumference peak signal, reference numeral 105d denotes a peak detector which performs peak detection for the outer circumference RF signal outputted from the amplifier 104d to generate an outer circumference peak signal, and reference numeral 106d denotes a subtracter which calculates a difference between the inner circumference peak signal and the outer circumference peak signal generated by the peak detectors 105c and 105d, respectively, to generate a lens position signal (LPOS).

Reference numeral 107 denotes a multiplexer which receives the RF peak signal and RF bottom signal outputted from the peak/bottom detector 105a, the track center signal TC and tilt signal TI outputted from the TCTI signal generator 106c, and the lens position signal LPOS outputted from the subtracter 106d, and selects one of these signals, and reference numeral 108 denotes an A/D converter which converts the signal selected by the multiplexer 107 into a digital signal.

FIG. 10 is a waveform diagram for explaining the operation of detecting the BDO signal and the OFTR signal, wherein the names of the respective signals are identical to those shown in FIG. 9.

A failure which exists on the surface of the optical disc or in the base material of the optical disc and blocks incident light and reflected light is called a dropout, and the dropout can be detected by detecting a change in the peak level of the RF signal. Accordingly, when the RF signal which is adjusted so as to be offset with a constant amplitude by the amplifier 104a shown in FIG. 9 is subjected to peak detection by the peak/bottom detector 105a, the waveform of the RF peak signal shown in FIG. 10 is obtained, and the BDO signal is obtained when this waveform is binarized with an appropriate threshold value.

Further, when the incident light moves between tracks due to jumping of the pickup or the like, since the RF signal amplitude is reduced at the intermediate point between the tracks although the maximum reflected light amount is not changed, the intermediate point between the tracks can be detected by detecting a change in the bottom level of the RF signal. Accordingly, when the RF signal which is adjusted so as to be offset with the constant amplitude by the amplifier 104a is subjected to bottom detection by the peak/bottom detector 105a, the waveform of the RF bottom signal shown in FIG. 10 is obtained, and the OFTR signal is obtained by binarizing this waveform with an appropriate threshold value.

FIG. 11 is a waveform diagram for explaining the operation of detecting the TC signal and the TI signal, showing one ID region enlarged. The names of the respective signals are identical to those shown in FIG. 9. As for the TC signal and the TI signal, the arithmetic formulae (VFO1p−VFO1b)−(VFO3p−VFO3b) and (VFO1b−VFO3b) for generating these signals are described below the signal names TC and TI, respectively. As shown in FIG. 11, VFO1p is the VFO1 peak signal, VFO1b is the VFO1 bottom signal, VFO3p is the VFO3 peak signal, and VFO3b is the VFO3 bottom signal.

In the reproduction of the optical disc, particularly, DVD-RAM, since the ID region in the RF signal has a positive offset to the recording region as shown in FIG. 11, the offset and gain of the RF signal are adjusted by the amplifier 104b shown in FIG. 9 so that the RF signal in the ID region is in the optimum range within the dynamic range, and the adjusted RF signal is input to the peak/bottom detector 105b and to the peak/bottom detector 105c.

The ID region is separated into the first half ID ½ and the second half ID ¾, and the gate signal 1 becomes effective in the VFO1 region in the ID ½ period while the gate signal 2 becomes effective in the VFO3 region in the ID ¾ period as shown in FIG. 11.

The peak/bottom detector 105b is operated to update the VFO1 peak signal and the VFO1 bottom signal while the gate signal 1 is effective, and the peak/bottom detector 105c is operated to update the VFO3 peak signal and the VFO3 bottom signal while the gate signal 2 is effective. When these gate signals are ineffective, the VFO1 peak signal, the VFO1 bottom signal, the VFO3 peak signal, and the VFO3 bottom signal are held.

The TCTI signal generator 106c shown in FIG. 9 generates the track center signal (TC) and the tilt signal (TI) from the four signals, i.e., the VFO1 peak signal (VFO1p), the VFO1 bottom signal (VFO1b), the VFO3 peak signal (VFO3p), and the VFO3 bottom signal (VFO3b) by performing the arithmetic operations, TC=(VFO1p−VFO1b)−(VFO3p−VFO3b) and TI=VFO1b−VFO3b, respectively.

FIG. 12 is a waveform diagram for explaining the operation of detecting the lens position signal (LPOS), wherein the nages of the respective signals are identical to those shown in FIG. 9.

The lens position signal (LPOS) is a detection signal for fixing the lens position in the radial direction when performing long-distance seek, and it is detected by that a push-pull signal caused by reflected light from a mirror part on the optical disc indicates the lens position. The reflected light from the mirror part can be detected by performing peak detection for the RF signal.

The inner circumference RF signal and the outer circumference RF signal which are generated by the adder 103b and the adder 103c shown in FIG. 9 are adjusted for their dynamic ranges by the amplifier 104c and the amplifier 104d, respectively, and the inner circumference peak signal and the outer circumference peak signal which are the peak detection signals of the RF signals are generated by the peak detector 105c and the peak detector 105d, respectively, and then a difference between these signals is calculated by the subtracter 106d to generate the lens position signal (LPOS).

FIG. 13 is a circuit diagram illustrating a typical circuit configuration used for the peak/bottom detector 105a which performs peak/bottom detection by an analog circuit in the RF signal detector shown in FIG. 9.

In FIG. 13, reference numeral 121 denotes an emitter-follower type NPN transistor having a base to which the RF signal is applied, reference numeral 122 denotes a capacitor which is charged by emitter current of the NPN transistor 121, and reference numeral 123 denotes a current source which slowly discharges the charges stored in the capacitor 122. The peak detector is configured by these NPN transistor 121, capacitor 122, and current source 123.

Further, reference numeral 124 denotes an emitter-follower type PNP transistor having a base to which the same RF signal as that inputted to the NPN transistor 121 is applied, reference numeral 125 denotes a capacitor which is charged by emitter current of the PNP transistor 124, and reference numeral 126 denotes a current source which slowly discharges the charges stored in the capacitor 125. The bottom detector is configured by these PNP transistor 124, capacitor 125, and current source 126.

The detection operations of the peak detector and the bottom detector will be described taking the peak detector as an example.

When the RF signal is input to the base terminal of the NPN transistor 121, the base current flows only when the base voltage becomes equal to or higher than (terminal voltage of capacitor 122)+Vbe (Vbe: base-emitter voltage of the transistor 121), and the emitter current which is hfe times as large as the base current is generated due to the current amplification function of the transistor, and charges are rapidly stored in the capacitor 122. Thereby, the terminal voltage of the capacitor 122 is charged at a voltage which is by Vbe lower than the maximum voltage of the RF signal, and it never exceeds this voltage, and thus peak detection is performed. Further, it is necessary to follow the variation in the peak voltage of the RF signal. When the peak voltage is increasing, the voltage of the capacitor 122 is increased by the above-described operation, and thereby it is possible to follow the variation in the peak voltage. However, when the peak voltage is decreasing, the variation in the peak voltage is followed by discharging of the capacitor 122 due to the current source 123. The operation of the bottom detector is identical to that of the peak detector except that the voltage orientation is inverted.

When implementing this circuit as an LSI, the capacitor 122 and the capacitor 125 are often externally provided. Even when these capacitors are embedded in the LSI, a relatively large area in the LSI is occupied by the capacitors only.

FIG. 14 is a circuit diagram illustrating a typical circuit configuration used for the binarizer 106a for binarizing the BDO signal with an analog circuit in the RF signal detector shown in FIG. 9.

In FIG. 14, reference numerals 131, 132, and 133 denote a NPN transistor, a capacitor, and a current source having the same configurations as the NPN transistor 121, the capacitor 122, and the current source 123 in the detection circuit shown in FIG. 13, respectively. By subjecting the detection signal which has once been peak-detected by the peak/bottom detector 105a to another peak detection having a lower discharging speed, a stable peak level signal which does not follow the variation in the peak level due to dropout can be generated. Further, reference numeral 134 denotes an adder in which a threshold value that is by a predetermined level lower than the peak level is set, and this adder 134 adds the threshold value to the peak level signal. Reference numeral 135 denotes a comparator which compares the detection signal with the output signal from the adder 134 to binarize the detection signal using the threshold value. Since the detection principle of the circuit for binarizing the OFTR signal is identical to that of the circuit for binarizing the BDO signal except that its polarity is inverted, these circuits have similar configurations.

When implementing this circuit by LSI, the capacitor 132 is fundamentally externally attached because of its large capacitance.

Further, FIG. 15 is a block diagram illustrating an RF signal detector obtained by digitizing the conventional optical disc recording/reproduction apparatus, as a second conventional art.

In FIG. 15, reference numeral 151 denotes a light-receiving element which is divided into four parts along the track tangential direction and the radial direction, and reference numeral 152 denotes an amplifier comprising four IV conversion amplifiers which IV-convert the output signals from the four light receiving elements A, B, C and D into which the light-receiving element 151 is divided. Reference numeral 153a denotes an adder which calculates a sum of signals which are obtained by amplifying the output signals from the two light-receiving elements A and D placed on the inner circumference side to generate an inner circumference RF signal, reference numeral 153b denotes an adder which calculates a sum of signals which are obtained by amplifying the output signals from the two light-receiving elements B and C placed on the outer circumference side, reference numerals 154a and 154b denote amplifiers which adjust the dynamic ranges of the output RF signals from the adders 153a and 153b, respectively, reference numerals 155a and 155b denote AD converters which AD-convert the output RF signals from the amplifiers 154a and 154b, respectively, and reference numeral 156 notes an adder which calculates a sum of the conversion results of the AD converters 155a and 155b to obtain an addition RF signal.

Further, reference numerals 157a and 157b denote a peak detector and a bottom detector which perform peak detection and bottom detection for the addition RF signal outputted from the adder 156 to generate an RF peak signal and an RF bottom signal, respectively, and reference numerals 160a and 160b denote binarizers which binarize the RF peak signal and the RF bottom signal which are detected by the peak detector 157a and the bottom detector 157b using appropriate threshold values to generate a BDO signal and an OFTR signal, respectively.

Further, reference numerals 158a and 158b denote a peak detector and a bottom detector which generate a peak signal and a bottom signal of VFO1 from the addition RF signal outputted from the adder 150 according to a VFO1 timing signal, respectively, reference numerals 158c and 158d denote a peak detector and a bottom detector which generate a peak signal and a bottom signal of VFO3 from the addition RF signal outputted from the adder 156 according to a VFO3 timing signal, respectively, and reference numeral 161 denotes a TCTI signal generator which generate a track center signal (TC) and a tilt signal (TI) from the VFO1 peak signal, the VFO1 bottom signal, the VFO3 peak signal, and the VFO3 bottom signal which are generated by the peak detector 158a, the bottom detector 158b, the peak detector 158c, and the bottom detector 158d, respectively.

Further, reference numerals 159a and 159b denote peak detectors which perform peak detections for the inner circumference RF signal and the outer circumference RF signal which have been AD-converted by the AD converters 155a and 155b, respectively, and reference numeral 162 denotes a subtracter which calculates a difference between the outputs of the peak detectors 159a and 159b. These elements perform generation of a lens position signal (LPOS) as in the first conventional art shown in FIG. 9.

As for the configuration of the peak detector, the most commonly used one includes comparing an AD-converted RF signal with a value stored in a register, rewriting the contents of the register with the value of the RF signal when the RF signal value is larger than the register value, and updating the data stored in the register with a value obtained by subtracting a predetermined value from the register value when the RF signal value is smaller than the register value. The comparator corresponds to the NPN transistor 121 shown in FIG. 13, the register corresponds to the capacitor 122, and the predetermined value to be subtracted corresponds to the constant current of the current source 123.

In the configuration of the second conventional art shown in FIG. 15, an AD converter having a conversion speed twice or more the RF signal frequency band is usually required in order to perform peak detection for the RF signal. However, there is a peak/bottom detector which, in order to reduce the circuit scale, performs probabilistic detection such that some of plural AD-converted values might be the peak level or the bottom level, with reducing the conversion speed of the AD converter and utilizing that the RF signal is a pseudo random signal (for example, refer to Patent Document 1). In this case, it is not necessary to use a high-speed AD converter.
Patent Document 1: Japanese Published Patent Application No. 2001-167440

### DISCLOSURE OF THE INVENTION

### Problems to be Solved by the Invention

As described above, in the first conventional art shown in FIG. 9, almost all the circuits are configured by analog circuits. Therefore, even when it is tried to reduce the chip size using micro processing, reduction in the chip size cannot be achieved because the sizes of the analog circuits are not reduced in proportion to the process rule. Further, since the capacitors included in the detector and the binarizer are externally placed, the number of terminals is undesirably increased.

Further, in the second conventional art shown in FIG. 15, since it is necessary to perform peak/bottom detection for the RF signal using the AD-converted data, the conversion speed of the AD converter should be at least twice, possibly four times, the RF signal frequency band, and therefore, a high-speed AD converter is required. Moreover, since two high-speed AD converters are required, the circuit scale is undesirably increased. Considering the dynamic range including the ID region and the detection accuracy for the track center signal and the wobble signal, an AD converter of 8-bit accuracy which is practical as a high-speed AD converter lacks the conversion accuracy, and therefore, it is necessary to increase the bit accuracy of the AD converter and add another AD converter, resulting in further increase in the circuit scale of the AD converter.

Further, when the conversion speed of the AD converter is reduced, a sample/hold circuit which has a higher speed than the RF frequency band is required to accurately obtain the peak level, and the response speed is reduced because the AD converter can perform only probabilistic peak detection.

The present invention is made to solve the above-described problems and has for its object to provide an optical disc recording/reproduction apparatus which can reduce the analog circuit scale by deleting the processes to be performed by analog circuits and replacing them with the processes to be performed by digital circuits, can reduce the chip size when using high-integration processing while suppressing increase in the analog circuit scale without using a high-speed AD converter, and can realize, regarding the performance, increase in the holding performance and securing of followability.

### Measures to Solve the Problems

In order to solve the above-described problems, according to Claim 1 of the present invention, there is provided an optical disc recording/reproduction apparatus comprising: a comparator to which a signal as a detection target is inputted; a digital-to-analog converter for threshold generation (hereinafter referred to as a threshold DAC) which generates a signal to be used as a threshold value when the comparator performs a comparison operation; and a detection controller which controls the threshold value of the threshold DAC upon receipt of the output from the comparator; said detection controller including a sampling unit which samples the output of the comparator with a sampling clock, a ratio converter which converts the binary output of the sampling unit into two constant values which are positive and negative, a low-pass filter which removes a high-frequency component from the output of the ratio converter, a sub-sampling unit which samples the output of the low-pass filter with a sub-sampling clock having a frequency equal to or smaller than that of the sampling clock, a gain unit which multiplies the output of the sub-sampling unit by a set gain, and an integrator which integrates the output of the gain unit and outputs the result to the threshold DAC.

According to Claim 2 of the present invention, in the optical disc recording/reproduction apparatus defined in Claim 1, the detection controller further includes an edge extension unit which extends an H period or L period of the output from the sampling unit by an approximately constant time, which edge extension unit is placed between the sampling unit and the ratio converter.

According to Claim 3 of the present invention, in the optical disc recording/reproduction apparatus defined in Claim 1, the detection controller further includes an edge extension unit which extends an H period or L period of the output from the comparator by an approximately constant time, which edge extension unit is placed in a stage prior to the sampling unit.

According to Claim 4 of the present invention, in the optical disc recording/reproduction apparatus defined in Claim 2 or 3, the edge extension unit prevents the H period or L period of the output from the comparator from becoming equal to or shorter than the constant time.

According to Claim 5 of the present invention, in the optical disc recording/reproduction apparatus defined in any of Claims 2 to 4, the extension time is approximately equal to a maximum appearance cycle or an average appearance cycle of a peak level or a bottom level of the input signal.

According to Claim 6 of the present invention, in the optical disc recording/reproduction apparatus defined in any of Claims 2 to 4, the extension time is 1/constant value with respect to a maximum appearance cycle or an average appearance cycle of a peak level or a bottom level of the input signal.

According to Claim 7 of the present invention, in the optical disc recording/reproduction apparatus defined in Claim, the sampling clock is controlled to be effective only during the detection period, and the sub-sampling clock is generated by frequency-dividing the sampling clock.

According to Claim 8 of the present invention, in the optical disc recording/reproduction apparatus defined in any of Claims 1, 2, 3 and 7, the ratio converter outputs “+1/−1” or “+N/−1”, “+1/−N” (N: positive integer) in response to “H/L” of the input logic value.

According to Claim 9 of the present invention, in the optical disc recording/reproduction apparatus defined in any of Claims 1 to 7, the ratio converter outputs “+P/−Q” (P and Q: positive integers) in response to “H/L” of the input logic value.

According to Claim 10 of the present invention, in the optical disc recording/reproduction apparatus defined in any of Claims 1, 2, 3 and 7, the low-pass filter has a cutoff frequency which is equal to or less than ½ of the frequency of the sub-sampling clock.

According to Claim 11 of the present invention, in the optical disc recording/reproduction apparatus defined in any of Claims 1, 2, 3 and 7, the sub-sampling clock has a cycle which is an integer multiple of the sampling clock, and the low-pass filter calculates a moving total or a moving average of sampling data which are equal in number to the ratio of the cycles of the sub-sampling clock and the sampling clock.

According to Claim 12 of the present invention, there is provided an optical disc recording/reproduction apparatus comprising: single or plural light-receiving elements which receive reflected light of a light beam incident on an optical disc; a signal generator which generates an RF signal from the outputs of the respective light-receiving elements; a comparator to which the RF signal is inputted; a threshold DAC which generates a signal to be used as a threshold value when the comparator performs a comparison operation; and a detection controller which outputs a threshold value signal to the threshold DAC upon receipt of the output from the comparator, and generates a detection signal; said detection controller including a sampling unit which samples the output of the comparator with a sampling clock, a ratio converter which converts the binary output of the sampling unit into two constant values which are positive and negative, a low-pass filter which removes a high-frequency component from the output of the ratio converter, a sub-sampling unit which samples the output of the low-pass filter with a sub-sampling clock having a frequency equal to or smaller than that of the sampling clock, a gain unit which multiplies the output of the sub-sampling unit by a set gain, and an integrator which integrates the output of the gain unit and outputs the result to the threshold DAC, and said detection controller being supplied with a sampling clock having a frequency which is set in response to the frequency of the RF signal.

According to Claim 13 of the present invention, there is provided an optical disc recording/reproduction apparatus comprising: a plurality of light-receiving elements which receive reflected light of a light beam incident on an optical disc; a plurality of signal generators which generate plural RF signals from the outputs of the plural light-receiving elements; a first selector which receives the plural RF signals, and selects and outputs one of the RF signals according to a first selection signal; a comparator to which the signal outputted from the first selector is inputted; a threshold DAC which generates a signal to be used as a threshold value when the comparator performs a comparison operation; a plurality of detection controllers which generate plural detection signals; a distributor which distributes the comparison result of the comparator to one of the plural detection controllers that is selected by a second selection signal; and a second selector which selects one of the threshold value signal outputs from the plural detection controllers, and outputs the selected signal to the threshold DAC; each of said plural detection controllers including a sampling unit which samples the output of the comparator with a sampling clock, a ratio converter which converts the binary output of the sampling unit into two constant values which are positive and negative, a low-pass filter which removes a high-frequency component from the output of the ratio converter, a sub-sampling unit which samples the output of the low-pass filter with a sub-sampling clock having a frequency equal to or smaller than that of the sampling clock, a gain unit which multiplies the output of the sub-sampling unit by a set gain, and an integrator which integrates the output of the gain unit and outputs the result to the threshold DAC, and said plural detection controllers being operated with plural sampling clocks applied thereto, and each of the sampling clocks having a frequency that is set in response to the frequency of the RF signal, and becoming effective only when the corresponding detection controller is selected by the second selection signal.

According to Claim 14 of the present invention, there is provided an optical disc recording/reproduction apparatus comprising: single or plural light-receiving elements which receive reflected light of a light beam incident on an optical disc, a signal generator which generates an RF signal from the outputs of the respective light-receiving elements; a first comparator to which the RF signal is inputted; a first threshold DAC which generates a signal to be used as a threshold value when the first comparator performs a comparison operation; a peak detection controller which outputs a threshold value signal to the first threshold DAC upon receipt of the output from the first comparator, and generates a peak detection signal; a second comparator to which the RF signal is inputted; a second threshold DAC which generates a signal to be used when the second comparator performs a comparison operation; and a bottom detection controller which outputs a threshold value signal to the second threshold DAC upon receipt of the output from the second comparator, and generates a bottom detection signal; each of said peak detection controller and said bottom detection controller including a sampling unit which samples the output of the comparator with a sampling clock, a ratio converter which converts the binary output of the sampling unit into two constant values which are positive and negative, a low-pass filter which removes a high-frequency component from the output of the ratio converter, a sub-sampling unit which samples the output of the low-pass filter with a sub-sampling clock having a frequency equal to or smaller than that of the sampling clock, a gain unit which multiplies the output of the sub-sampling unit by a set gain, and an integrator which integrates the output of the gain unit and outputs the result to the threshold DAC, and said peak detection controller and said bottom detection controller being supplied with sampling clocks having frequencies that are set in response to the frequency of the RF signal.

According to Claim 15 of the present invention, the optical disc recording/reproduction apparatus defined in Claim 14 further includes a subtracter which calculates a difference between the output of the peak detection controller and the output of the bottom detection controller to generate an amplitude signal, and the peak detection controller and the bottom detection controller change the control parameters according to the amplitude signal.

According to Claim 16 of the present invention, in the optical disc recording/reproduction apparatus defined in Claim 15, the control parameter is an amplification factor used when the detection controller generates a threshold value signal to be outputted to the threshold DAC.

According to Claim 17 of the present invention, there is provided an optical disc recording/reproduction apparatus comprising: a plurality of light-receiving elements which receive reflected light of a light beam incident on an optical disc; a plurality of signal generators which generate plural RF signals from the outputs of the plural light-receiving elements; a first selector which receives the plural RF signals, and selects and outputs one of the RF signals according to a first selection signal; first and second comparators to which the signal outputted from the first selector is inputted; first and second threshold DACs which generate signals to be used as threshold values when the first and second comparators perform comparison operations, respectively; a plurality of peak detection controllers which generate plural peak detection signals; a plurality of bottom detection controllers which generate plural bottom detection signals; a first distributor which distributes the comparison result of the first comparator to one of the plural peak detection controllers which is selected by the second selection signal; a second distributor which distributes the comparison result of the second comparator to one of the plural bottom detection controllers which is selected by the second selection signal; a second selector which selects one of the threshold value signal outputs of the plural peak detection controllers according to the second selection signal, and inputs the selected signal to the first threshold DAC; and a third selector which selects one of the threshold value signal outputs from the plural bottom detection controllers according to the second selection signal, and outputs the selected signal to the second threshold DAC; each of said plural peak detection controllers and said plural bottom detection controllers including a sampling unit which samples the output of the comparator with a sampling clock, a ratio converter which converts the binary output of the sampling unit into two constant values which are positive and negative, a low-pass filter which removes a high-frequency component from the output of the ratio converter, a sub-sampling unit which samples the output of the low-pass filter with a sub-sampling clock having a frequency equal to or smaller than that of the sampling clock, a gain unit which multiplies the output of the sub-sampling unit by a set gain, and an integrator which integrates the output of the gain unit and outputs the result to the threshold DAC, and said peak detection controllers and said bottom detection controllers being operated with plural sampling clocks applied thereto, and each of the sampling clocks having a frequency that is set in response to the frequency of the RF signal, and becoming effective only when the corresponding detection controller is selected by the second selection signal.

### Effects of the Invention

An optical disc recording/reproduction apparatus according to Claim 1 of the present invention comprises a comparator to which a signal as a detection target is inputted; a digital-to-analog converter for threshold generation (hereinafter referred to as a threshold DAC) which generates a signal to be used as a threshold value when the comparator performs a comparison operation; and a detection controller which controls the threshold value of the threshold DAC upon receipt of the output from the comparator; said detection controller including a sampling unit which samples the output of the comparator with a sampling clock, a ratio converter which converts the binary output of the sampling unit into two constant values which are positive and negative, a low-pass filter which removes a high-frequency component from the output of the ratio converter, a sub-sampling unit which samples the output of the low-pass filter with a sub-sampling clock having a frequency equal to or smaller than that of the sampling clock, a gain unit which multiplies the output of the sub-sampling unit by a set gain, and an integrator which integrates the output of the gain unit and outputs the result to the threshold DAC. Therefore, the digital value of the detection result signal can be obtained directly from the detection target analog signal, the detection efficiency can be arbitrarily varied by varying the setting of the ratio converter, the detection result which is not likely to be affected by noises in the detection target signal can be obtained by the low-pass filter, the operation clock frequency for the subsequent processing can be lowered by the sub-sampling unit to reduce the power consumption, and the followability of the detection operation can be arbitrarily set by the gain unit which can variably set the gain.

Further, according to Claim 2 of the present invention, in the optical disc recording/reproduction apparatus defined in Claim 1, the detection controller further includes an edge extension unit which extends an H period or L period of the output from the sampling unit by an approximately constant time, which extension unit is placed between the sampling unit and the ratio converter. Therefore, even when the detection target signal is a signal having a poor symmetrical property and a small duty ratio, an accurate peak level can be detected.

Further, according to Claim 3 of the present invention, in the optical disc recording/reproduction apparatus defined in Claim 1, the detection controller further includes an edge extension unit which extends an H period or L period of the output from the comparator by an approximately constant time, which edge extension unit is placed in a stage prior to the sampling unit. Therefore, even when the detection target signal is a signal having a poor symmetrical property and an extremely small duty ratio, whose H period or L period is equal to or shorter than the sampling clock cycle, it can be extended after being reliably sampled, and thereby an accurate peak level can be detected.

Further, according to Claim 4 of the present invention, in the optical disc recording/reproduction apparatus defined in Claim 2 or 3, the edge extension unit prevents the H period or L period of the output from the comparator from becoming equal to or shorter than the constant time. Therefore, the edge extension is performed only when the H period or the L period is short, and it is not performed in other cases, and thereby the response speed of the detection operation can be increased.

Further, according to Claim 5 of the present invention, in the optical disc recording/reproduction apparatus defined in any of Claims 2 to 4, the extension time is approximately equal to a maximum appearance cycle or an average appearance cycle of a peak level or a bottom level of the input signal. Therefore, the followability can be secured without being affected by a certain degree of variation in the peak occurrence cycle of the detection target signal.

Further, according to Claim 6 of the present invention, in the optical disc recording/reproduction apparatus defined in any of Claims 2 to 4, the extension time is 1/constant value with respect to a maximum appearance cycle or an average appearance cycle of a peak level or a bottom level of the input signal. Therefore, the response speed of the detection operation can be increased by reducing the edge extension time.

Further, according to Claim 7 of the present invention, in the optical disc recording/reproduction apparatus defined in Claim, the sampling clock is controlled to be effective only during the detection period, and the sub-sampling clock is generated by frequency-dividing the sampling clock. Therefore, the detection process can be temporally separated, and thereby the intermittently generated signal can be detected, and further, a plurality of signals can be simultaneously detected by time-divisionally sharing the comparator and the threshold DAC, and thus the detection process can be performed for only a specific portion of the detection target signal as a detection target.

Further, according to Claim 8 of the present invention, in the optical disc recording/reproduction apparatus defined in any of Claims 1, 2, 3 and 7, the ratio converter outputs “+1/−1” or “+N/−1”, “+1/−N” (N: positive integer) in response to “H/L” of the input logic value. Therefore, the detection efficiency can be arbitrarily varied by controlling the duty ratio of the comparator output.

Further, according to Claim 9 of the present invention, in the optical disc recording/reproduction apparatus defined in any of Claims 1 to 7, the ratio converter outputs “+P/−Q” (P and Q: positive integers) in response to “H/L” of the input logic value. Therefore, the detection efficiency can be more arbitrarily varied by controlling the duty ratio of the comparator output.

Further, according to Claim 10 of the present invention, in the optical disc recording/reproduction apparatus defined in any of Claims 1, 2, 3 and 7, the low-pass filter has a cutoff frequency which is equal to or less than ½ of the frequency of the sub-sampling clock. Therefore, the low-pass filter functions as an anti-aliasing filter, and thereby aliasing in the subsequent-stage sub-sampling unit can be avoided.

Further, according to Claim 11 of the present invention, in the optical disc recording/reproduction apparatus defined in any of Claims 1, 2, 3 and 7, the sub-sampling clock has a cycle which is an integer multiple of the sampling clock, and the low-pass filter calculates a moving total or a moving average of sampling data which are equal in number to the ratio of the cycles of the sub-sampling clock and the sampling clock. Therefore, the low-pass filter which provides the effect as an anti-aliasing filter can be realized by a simple circuit configuration.

Further, according to Claim 12 of the present invention, there is provided an optical disc recording/reproduction apparatus comprising: single or plural light-receiving elements which receive reflected light of a light beam incident on an optical disc; a signal generator which generates an RF signal from the outputs of the respective light-receiving elements; a comparator to which the RF signal is inputted; a threshold DAC which generates a signal to be used as a threshold value when the comparator performs a comparison operation; and a detection controller which outputs a threshold value signal to the threshold DAC upon receipt of the output from the comparator, and generates a detection signal; said detection controller including a sampling unit which samples the output of the comparator with a sampling clock, a ratio converter which converts the binary output of the sampling unit into two constant values which are positive and negative, a low-pass filter which removes a high-frequency component from the output of the ratio converter, a sub-sampling unit which samples the output of the low-pass filter with a sub-sampling clock having a frequency equal to or smaller than that of the sampling clock, a gain unit which multiplies the output of the sub-sampling unit by a set gain, and an integrator which integrates the output of the gain unit and outputs the result to the threshold DAC, and said detection controller being supplied with a sampling clock having a frequency which is set in response to the frequency of the RF signal. Therefore, the digital value of the detection result signal can be obtained directly from the analog RF signal, the detection efficiency can be arbitrarily varied by varying the setting of the ratio converter, the detection result which is not likely to be affected by noises in the detection target signal can be obtained by the low-pass filter, the operation clock frequency for the subsequent processing can be lowered by the sub-sampling unit to reduce the power consumption, and the followability of the detection operation can be arbitrarily set by the gain unit which can variably set the gain.

Further, according to Claim 13 of the present invention, there is provided an optical disc recording/reproduction apparatus comprising: a plurality of light-receiving elements which receive reflected light of a light beam incident on an optical disc; a plurality of signal generators which generate plural RF signals from the outputs of the plural light-receiving elements; a first selector which receives the plural RF signals, and selects and outputs one of the RF signals according to a first selection signal; a comparator to which the signal outputted from the first selector is inputted; a threshold DAC which generates a signal to be used as a threshold value when the comparator performs a comparison operation; a plurality of detection controllers which generate plural detection signals; a distributor which distributes the comparison result of the comparator to one of the plural detection controllers that is selected by a second selection signal; and a second selector which selects one of the threshold value signal outputs from the plural detection controllers, and outputs the selected signal to the threshold DAC; each of said plural detection controllers including a sampling unit which samples the output of the comparator with a sampling clock, a ratio converter which converts the binary output of the sampling unit into two constant values which are positive and negative, a low-pass filter which removes a high-frequency component from the output of the ratio converter, a sub-sampling unit which samples the output of the low-pass filter with a sub-sampling clock having a frequency equal to or smaller than that of the sampling clock, a gain unit which multiplies the output of the sub-sampling unit by a set gain, and an integrator which integrates the output of the gain unit and outputs the result to the threshold DAC, and said plural detection controllers being operated with plural sampling clocks applied thereto, and each of the sampling clocks having a frequency that is set in response to the frequency of the RF signal, and becoming effective only when the corresponding detection controller is selected by the second selection signal. Therefore, it is possible to detect the plural RF signals by one set of the comparator and the threshold DAC.

Further, according to Claim 14 of the present invention, there is provided an optical disc recording/reproduction apparatus comprising: single or plural light-receiving elements which receive reflected light of a light beam incident on an optical disc, a signal generator which generates an RF signal from the outputs of the respective light-receiving elements; a first comparator to which the RF signal is inputted; a first threshold DAC which generates a signal to be used as a threshold value when the first comparator performs a comparison operation; a peak detection controller which outputs a threshold value signal to the first threshold DAC upon receipt of the output from the first comparator, and generates a peak detection signal; a second comparator to which the RF signal is inputted; a second threshold DAC which generates a signal to be used when the second comparator performs a comparison operation; and a bottom detection controller which outputs a threshold value signal to the second threshold DAC upon receipt of the output from the second comparator, and generates a bottom detection signal; each of said peak detection controller and said bottom detection controller including a sampling unit which samples the output of the comparator with a sampling clock, a ratio converter which converts the binary output of the sampling unit into two constant values which are positive and negative, a low-pass filter which removes a high-frequency component from the output of the ratio converter, a sub-sampling unit which samples the output of the low-pass filter with a sub-sampling clock having a frequency equal to or smaller than that of the sampling clock, a gain unit which multiplies the output of the sub-sampling unit by a set gain, and an integrator which integrates the output of the gain unit and outputs the result to the threshold DAC, and said peak detection controller and said bottom detection controller being supplied with sampling clocks having frequencies that are set in response to the frequency of the RF signal. Therefore, the digital values of the peak detection result and the bottom detection result can be obtained directly from the analog RF signal, the detection efficiency can be arbitrarily varied by varying the setting of the ratio converter, the detection result which is not likely to be affected by noises in the detection target signal can be obtained by the low-pass filter, the operation clock frequency for the subsequent processing can be lowered by the sub-sampling unit to reduce the power consumption, and the followability of the detection operation can be arbitrarily set by the gain unit which can variably set the gain.

Further, according to Claim 15 of the present invention, the optical disc recording/reproduction apparatus defined in Claim 14 further includes a subtracter which calculates a difference between the output of the peak detection controller and the output of the bottom detection controller to generate an amplitude signal, and the peak detection controller and the bottom detection controller change the control parameters according to the amplitude signal. Therefore, the detection performance is made constant regardless of the amplitude of the RF signal.

Further, according to Claim 16 of the present invention, in the optical disc recording/reproduction apparatus defined in Claim 15, the control parameter is an amplification factor used when the detection controller generates a threshold value signal to be outputted to the threshold DAC. Therefore, the followability is made constant regardless of the amplitude of the RF signal.

Further, according to Claim 17 of the present invention, there is provided an optical disc recording/reproduction apparatus comprising: a plurality of light-receiving elements which receive reflected light of a light beam incident on an optical disc; a plurality of signal generators which generate plural RF signals from the outputs of the plural light-receiving elements; a first selector which receives the plural RF signals, and selects and outputs one of the RF signals according to a first selection signal; first and second comparators to which the signal outputted from the first selector is inputted; first and second threshold DACs which generate signals to be used as threshold values when the first and second comparators perform comparison operations, respectively; a plurality of peak detection controllers which generate plural peak detection signals; a plurality of bottom detection controllers which generate plural bottom detection signals; a first distributor which distributes the comparison result of the first comparator to one of the plural peak detection controllers which is selected by the second selection signal; a second distributor which distributes the comparison result of the second comparator to one of the plural bottom detection controllers which is selected by the second selection signal; a second selector which selects one of the threshold value signal outputs of the plural peak detection controllers according to the second selection signal, and inputs the selected signal to the first threshold DAC; and a third selector which selects one of the threshold value signal outputs from the plural bottom detection controllers according to the second selection signal, and outputs the selected signal to the second threshold DAC; each of said plural peak detection controllers and said plural bottom detection controllers including a sampling unit which samples the output of the comparator with a sampling clock, a ratio converter which converts the binary output of the sampling unit into two constant values which are positive and negative, a low-pass filter which removes a high-frequency component from the output of the ratio converter, a sub-sampling unit which samples the output of the low-pass filter with a sub-sampling clock having a frequency equal to or smaller than that of the sampling clock, a gain unit which multiplies the output of the sub-sampling unit by a set gain, and an integrator which integrates the output of the gain unit and outputs the result to the threshold DAC, and said peak detection controllers and said bottom detection controllers being operated with plural sampling clocks applied thereto, and each of the sampling clocks having a frequency that is set in response to the frequency of the RF signal, and becoming effective only when the corresponding detection controller is selected by the second selection signal. Therefore, peak detection and bottom detection for the plural RF signals can be performed by two sets of the comparators and the threshold DACs.

### BRIEF DESCRIPTION OF THE DRAWINGS

FIG. 1 is a diagram illustrating an optical disc recording/reproduction apparatus according to a first embodiment of the present invention, wherein FIG. 1(a) is a block diagram thereof, and FIG. 1(b) is a diagram showing a table of typical set values to a ratio converter 3.

FIG. 2 is a diagram illustrating a timing chart of operation at (+1,−1) setting.

FIG. 3 is a diagram illustrating a timing chart of operation at (+15,−1) setting.

FIG. 4 is a block diagram of an optical disc recording/reproduction apparatus according to a second embodiment of the present invention.

FIG. 5 is a block diagram of an optical disc recording/reproduction apparatus according to a third embodiment of the present invention.

FIG. 6 is a block diagram of an optical disc recording/reproduction apparatus according to a fourth embodiment of the present invention.

FIG. 7 is a block diagram of an optical disc recording/reproduction apparatus according to a fifth embodiment of the present invention.

FIG. 8(a) is a block diagram illustrating the configuration of an optical disc recording/reproduction apparatus according to a sixth embodiment of the present invention in the case where the operation of a controller is switched with a clock signal.

FIG. 8(b) is a block diagram illustrating the configuration of the optical disc recording/reproduction apparatus according to the sixth embodiment in the case where the operation of the controller is switched with a control signal.

FIG. 9 is a block diagram illustrating a first conventional example of the present invention.

FIG. 10 is a waveform diagram for explaining the operation of detecting BDO and OFTR signals.

FIG. 11 is a waveform diagram for explaining the operation of detecting TC and TI signals.

FIG. 12 is a waveform diagram for explaining the operation of detecting a lens position signal (LPOS).

FIG. 13 is a circuit diagram illustrating a typical circuit configuration which is used for peak/bottom detection.

FIG. 14 is a circuit diagram illustrating a typical circuit configuration which is used for binarization of a BDO signal.

FIG. 15 is a block diagram illustrating a second conventional example of the present invention.

### DESCRIPTION OF REFERENCE NUMERALS

1 . . . comparator

2 . . . sampling unit

3 . . . ratio converter

4 . . . low-pass filter

5 . . . sub-sampling unit

6 . . . gain unit

7 . . . integrator

8 . . . threshold DAC

9 . . . edge extension unit

10 . . . frequency divider

11 . . . switch

500,600,700 . . . detection controller

### BEST MODE TO EXECUTE THE INVENTION

Hereinafter, best modes to execute the present invention will be described with reference to the drawings. The present invention realizes a considerable reduction in the circuit scale by directly generating a digital detection signal from an analog RF signal using a simple analog circuit configuration which includes a comparator, a threshold DAC for setting a threshold value for the comparator, and a detection controller for controlling the threshold DAC upon receipt of the output from the comparator.

### Embodiment 1

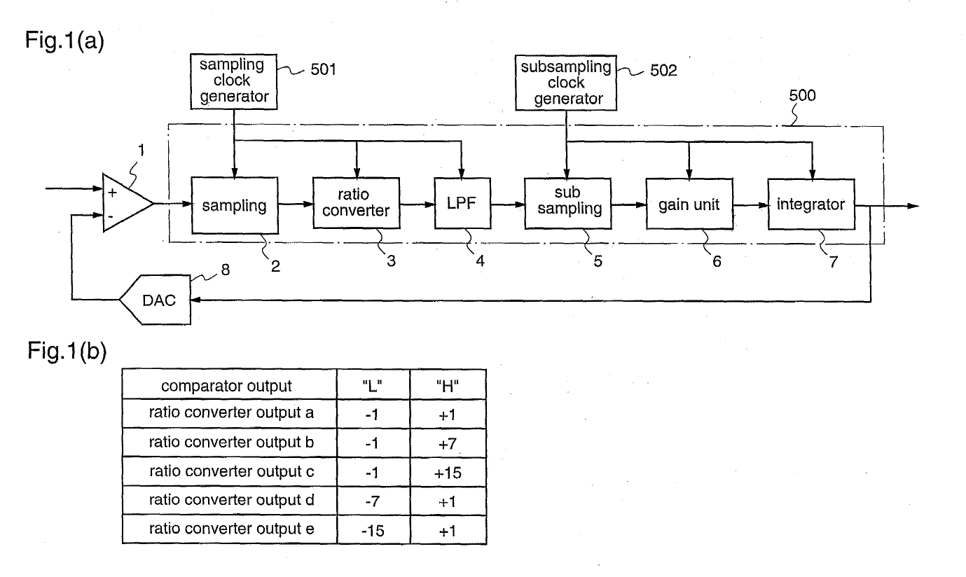

FIG. 1(a) is a block diagram of an optical disc recording/reproduction apparatus according to a first embodiment of the present invention.

In FIG. 1, reference numeral 1 denotes a comparator to which a signal as a detection target is inputted, reference numeral 2 denotes a sampling unit which samples the output of the comparator 1 with a sampling clock, reference numeral 3 denotes a ratio converter which converts the binary output of the sampling unit 2 into two constant values of positive and negative, reference numeral 4 denotes a low-pass filter which removes high-frequency components from a series of numerical outputs from the ratio converter 3, reference numeral 5 denotes a sub-sampling unit which samples the output of the low-pass filter 4 with a sub-sampling clock having a cycle that is an integer multiple of the sampling clock, reference numeral 6 denotes a gain unit which multiplies the output of the sub-sampling unit 5 by a set gain, reference numeral 7 denotes an integrator which integrates the output of the gain unit 6, and reference numeral 8 denotes a threshold DAC which DA-converts the output of the integrator 7 to output a threshold value for the comparator 1.

Further, reference numeral 500 denotes a detection controller which controls the threshold value of the threshold DAC 8 upon receipt of the output of the comparator 1, and this detection controller 500 comprises the sampling unit 2, the ratio converter 3, the low-pass filter 4, the sub-sampling unit 5, the gain unit 6, and the integrator 7. Reference numeral 501 denotes a sampling clock generator which generates a sampling clock, and reference numeral 502 denotes a sub-sampling clock generator which generates a sub-sampling clock.

The detection target signal and the threshold value generated by the threshold DAC 8 are input to the comparator 1, and the sampling unit 2, the ratio converter 3, and the low-pass filter 4 are operated with the sampling clock, while the sub-sampling unit 5, the gain unit 6, the integrator 7, and the threshold DAC 8 are operated with the sub-sampling clock.

FIG. 1(b) is a table showing typical set values to the ratio converter 3.

Initially, the operation in the case where the set value of the ratio comparator 3 is (+1,−1) will be described.

The input signal to the comparator 1 is the RF signal reproduced from the optical disc, and the sampling clock is set at a frequency which is approximately equal to the bit rate of the RF signal. For example, assuming that a DVD is played at a speed of 4×, the frequency of the sampling clock is appropriately about 100 MHz.

The RF signal inputted to the comparator 1 is binarized in comparator 1 using the threshold value set by the threshold DAC 8, and this binarized signal is sampled in the sampling unit 2 using the sampling clock, thereby enabling the subsequent processes to be simultaneously carried out.

A target value of duty of the binarized signal that is sampled by the sampling unit 2 is set by the ratio converter 3. That is, the ratio converter 3 sets a target value of duty of the binarized signal, and for example, setting (+1,−1) indicates an average level detection with the duty ratio of “H/L” being 50%, setting (+15,−1) indicates a peak detection with the duty ratio being 6.2%(=1/16), and setting (+1,−15) indicates a bottom detection with the duty ratio being 93.7%(=15/16). Since the description is now advanced with the target value of duty being set at (+1,−1), the ratio converter 3 outputs “+1” and “−1” when the inputted binarized signal is “H” and “L”, respectively.

One of the set values is not necessarily +1 or −1, but it may be an arbitrary numeral value to obtain a required duty ratio.

The binarized signal for which the target value of duty is set by the ratio converter 3 is outputted to the low-pass filter 4. The low-pass filter 4 functions as an anti-aliasing filter for enabling the subsequent processes to be performed while being subsampled. For example, when the sub-sampling clock is 1/32 of the sampling clock, such as an averaging process using 32 stages of registers is performed so as to simplify the circuit configuration, but a sophisticated filter such as an FIR filter may be designed depending on circumstances.

The output from the low-pass filter 4 is input to the sub-sampling unit 5. The sub-sampling unit 5 thins the output of the low-pass filter 4 with the sub-sampling clock so that the subsequent data processing can be performed using the sub-sampling clock.

The output from the sub-sampling unit 5 is input to the gain unit 6. The gain unit 6 adjusts the loop gain of a threshold control loop comprising the comparator 1, the sampling unit 2, the ratio converter 3, the low-pass filter 4, the sub-sampling unit 5, the gain unit 6, the integrator 7, and the threshold DAC 8.

The output from the gain unit 6 is input to the integrator 7. The integrator 7 performs integration of the output from the ratio converter 3 together with the low-pass filter 4, and the output of the integrator 7 is stabilized when the occurrence frequencies of +1 and −1 become equal to each other in the case where the ratio converter 3 is set at (+1,−1). The output value of the integrator is increased with an increase in the occurrence frequency of +1, and it is reduced with an increase in the occurrence frequency of −1.

The output from the integrator 7 is input to the threshold DAC 8. Since the threshold DAC 8 is driven by the output of the integrator 7, the above-described state where the occurrence frequencies of +1 and −1 become equal to each other means that the duty of the binarization result due to the threshold value at that time is 50%. With this threshold value being a boundary, the duty is decreased as the threshold value is increased, and the duty is increased as the threshold value is decreased. Thereby, the output of the integrator 7 is decreased as the threshold value is increased and it is increased as the threshold value is decreased, and the feedback system goes into the negative feedback state when the output of the integrator 7 is input to the threshold DAC 8, and thus the position at which the duty is 50% is stable.

By the way, since an EFM (Eight to Fourteen Modulation) signal which is an RF signal of a DVD or a CD is modulated such that its DSV (Data Sum Value) becomes zero, the average duty of its binarized signal becomes 50% when binarization is performed with the center level of the RF signal being a threshold value.

As described above, when the ratio converter 3 is set at (+1,−1), since the output of the threshold DAC 8 is stabilized at the center level of the inputted RF signal, the output value from the integrator 7 indicates the average value of the inputted RF signal.

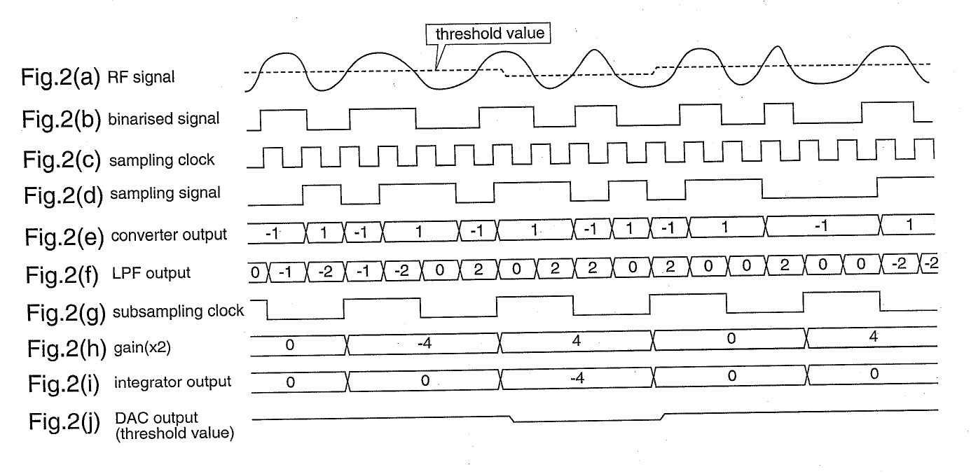

FIG. 2 is a timing chart showing, except that the frequency of the sub-sampling clock is ¼ of the frequency of the sampling clock, an example of the above-described operation because of space limitation.

While in the above description the frequency of the sub-sampling clock is set to 1/32 of the frequency of the sampling clock, this value is not particularly determined, but it may be arbitrarily determined.

Next, the operation in the case where the set value of the ratio converter 3 is (+15,−1) will be described.

As described above, the stabilization point of the threshold value is when the binarized signal has the duty with which the value of the integrator 7 is stabilized. Since the ratio converter 3 outputs +15 when the binarized signal is “H” and −1 when it is “L”, if “L” occurs fifteen times while “H” occurs one time, the integration result becomes zero and thereby the output of the integrator 7 is stabilized. The threshold level at which the duty of the binarized signal becomes 6.2%(1/16) is obtained when a threshold value level that is approximately near the peak is set for the RF signal.

As described above, when the set value of the ratio converter 3 is (+15,−1), the value of the integrator 7 shows the level that is close to the peak level of the RF signal. Further, the position where the duty is 6.2% is also stable as in the case where the ratio converter 3 is set at (+1,−1).

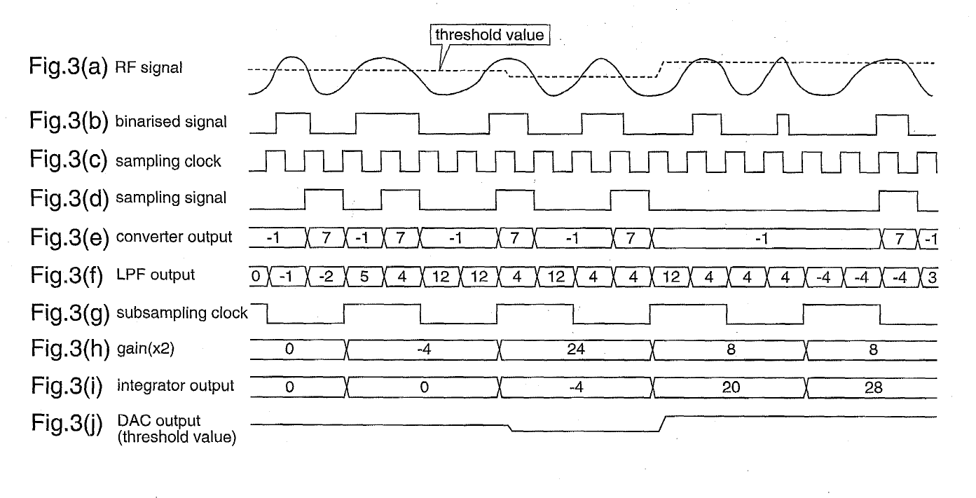

FIG. 3 shows, similarly to FIG. 2, the above-described operation in a timing chart.

Also in this case, bottom detection can be realized by setting the ratio converter at (+1,−15).

Further, the set value of the ratio converter 3 is not restricted to those mentioned above, but it may be arbitrarily set. For example, setting at (+1,−7) or (+1,−31) is also possible.

As described above, according to the first embodiment, the input signal as a detection target is binarized, and the binarized signal is subjected to sampling, ratio conversion, and extraction of its low-frequency component by the sampling unit, the ratio converter, and the low-pass filter which are operated with the sampling clock, respectively, and thereafter, the extracted low-frequency component signal is subjected to sub-sampling, adjustment for loop gain, and integration by the sub-sampling unit, the gain unit, and the integrator which are operated with the sub-sampling signal, respectively, thereby to perform peak detection or bottom detection, and further, this integration result is DA-converted to be used as a threshold value for binarization. Therefore, it is possible to reduce the scale of the analog circuit including the parts which are externally attached or occupy a large space in an LSI when large-scale integration is performed, and obtain a digital detection output directly from the analog RF signal without using a high-speed and large-scale AD converter.

### Embodiment 2

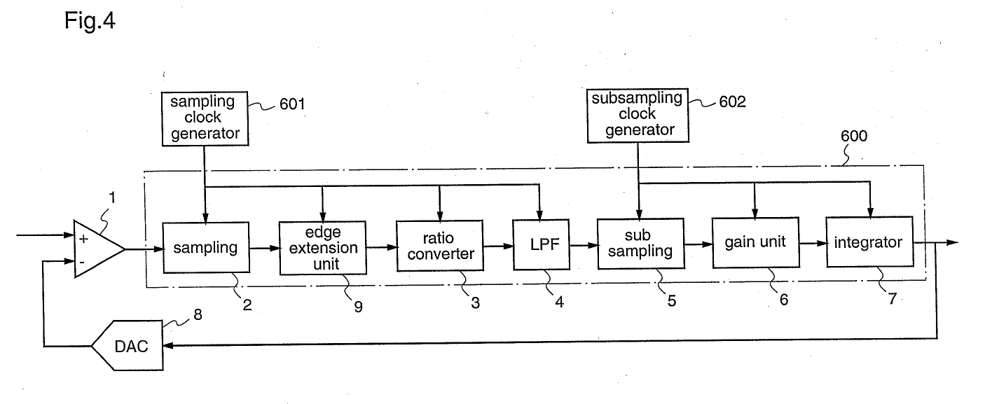

FIG. 4 is a block diagram illustrating an optical disc recording/reproduction apparatus according to a second embodiment of the present invention.

Although a detection result which is almost close to the peak level can be obtained by setting the duty to 1/16 when the RF signal is close to a sinusoidal wave such as an optical disc reproduction RF signal, detection of a peak level cannot be performed when the duty of the RF signal itself is not 50%. For example, if the duty of the RF signal becomes 20% in such as a test recording/reproduction waveform for recording learning, the peak detection system of the first embodiment cannot execute measurement of a peak level.

In this second embodiment, in order to solve the problem of the first embodiment, an edge extension unit 9 is added between the sampling unit 2 and the ratio converter 3 in the detection controller 500 of the first embodiment shown in FIG. 1.

This edge extension unit 9 extends the “H” level when performing peak detection, and extends the “L” level when performing bottom detection. Further, the ratio converter 3 is set at (+1,−1).

Further, a detection controller 600 is configured by adding the edge extension unit 9 between the sampling unit 2 and the ratio converter 3 in the detection controller 500 shown in FIG. 1. Further, reference numeral 601 denotes a sampling clock generator for generating a sampling clock, and reference numeral 602 denotes a sub-sampling clock generator for generating a sub-sampling clock.

When the RF signal to be a detection target is a reproduction signal from a DVD, the extension amount of the edge extension unit 9 may be set at 20 T which is approximately twice of about 10 T that is the average value of the interval of the mark centers (1 T is one cycle of a channel clock and equal to the length of 1 bit of channel data), or it may be set at about 100 T based on the average interval of long marks not shorter than 8 T.

Hereinafter, the operation will be described.

Assuming that an RF signal having a significantly large asymmetricity is inputted and the threshold value is near the peak level, the binarized signal becomes short pulses with intervals not shorter than 10 T.

The edge extension unit 9 fills up the intervals so that the binarized signal is continuously “H” while the peak level of the RF signal exceeds the threshold value. The binarized signal is continuously “L” while the peak level does not exceed the threshold value.

Since the peak level of the RF signal varies with a relatively slow frequency, when the threshold value is the average value of the peak level, the output from the edge extension unit 9 is a signal in which the frequencies of “H” and “L” are approximately equal to each other. Accordingly, by setting the ratio converter 3 at (+1,−1), the average value of the peak level of the RF signal having a significantly large asymmetricity can be measured.

When performing bottom detection, the edge extension unit 9 performs the extension operation for the “L” level to convert the short pulses on the “L” side into a continuous signal, thereby realizing the bottom level detection.

While in this second embodiment the edge extension unit 9 is placed the sampling unit 2, there may occur a case where the binarized signal is not sampled in the sampling unit 2 when the pulse width of the binarized signal is extremely short. In this case, since the output from the edge extension unit 9 which is supposed to be continuous is intermittent, the level of the detection result might be lower than the original level. As a countermeasure against this phenomenon, the output from the comparator is directly input to the edge extension unit 9, and the extended result is sampled by the sampling unit 2.

In the above description, assumed is the state where the ratio converter is set at (+1,−1) and the extension amount of the edge extension unit is set at 20 T or 100 T. However, with the ratio converter being set at (+15,−1) so that the threshold control becomes 1/15 duty, the extension amount of the edge extension unit may be set at 1/constant value of the average interval of the long marks not less than 8 T, for example, at 7 T which is about 1/15 of 100 T.

In this case, while the threshold value is controlled to the state where the H period of 7 T that is about 1/15 of 100 T exists in the period of average 100 T, this state is satisfied if at least one H period occurs in the period of 100 T, and the threshold value becomes approximately equal to the peak level because the RF signal level in the long mark reaches the peak level. That is, even when the peak level of the RF signal is extremely short, the peak level can be detected similarly as described above, and the detection response speed is increased because the edge extension time is short.

As described above, according to the second embodiment, the input signal as a detection target is binarized, and the binarized signal is subjected to sampling, extension of “H” or “L” level period, ratio conversion, and extraction of low-frequency component by the sampling unit, the edge extension unit, the ratio converter, and the low-pass filter which are operated with the sampling clock, respectively, and thereafter, the extracted low-frequency component signal is subjected to sub-sampling, adjustment of loop gain, and integration by the sub-sampling unit, the gain unit, and the integrator which are operated with the sub-sampling clock, respectively, thereby to perform peak detection and bottom detection, and further, the integration result is DA- converted to be used as a threshold value for binarization. Therefore, it is possible to reduce the scale of the analog circuit including the parts which are externally attached or occupy a large space in an LSI when large-scale integration is performed, and obtain a digital detection output directly from the analog RF signal having a significantly large asymmetricity without using a high-speed and large-scale AD converter.

### Embodiment 3

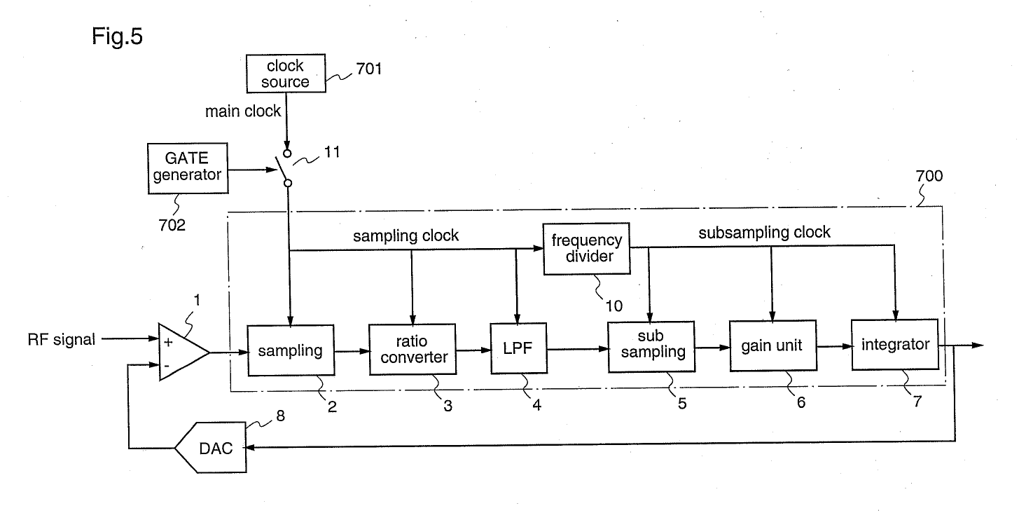

FIG. 5 is a block diagram of an optical disc recording/reproduction apparatus according to a third embodiment of the present invention. This third embodiment is configured by adding, to the configuration of the first embodiment shown in FIG. 1, a switch 11 which turns on and off a main clock supplied from a clock source 701 with a gate signal GATE to generate a sampling clock, a gate signal generator 702 which generates the gate signal GATE, and a frequency divider 10 which frequency-divides the sampling clock to generate a sub-sampling clock.

Further, a detection controller 700 corresponds to the detection controller 500 shown in FIG. 1 to which the frequency divider 10 is added.

Hereinafter, the operation of the optical disc recording/reproduction apparatus of this third embodiment will be described with respect to the case where, when an optical disc to be played is a DVD-RAM, the gate signal of the switch 11 is set to be effective in the ID region of the DVD-RAM.

In this case, since the clock is effective only in the ID region, the detection operation is halted outside the ID region and all the parameters including the inner state are held, while the above-described detection operation is carried out in the ID region, and thereby a detection result for only the ID region can be obtained.

That is, the RF signal inputted to the comparator 1 is binarized by the comparator 1 using the threshold value that is set by the threshold DAC 8, and this binarized signal is sampled by the sampling unit 2 using the sampling clock. The binarized signal sampled by the sampling unit 2 is set for its target value of duty by the ratio converter 3.

The binarized signal for which the target value of duty is set by the ratio converter 3 is outputted to the low-pass filter 4. The low-pass filter 4 functions as an anti-aliasing filter which enables the subsequent processing to be performed while being subsampled, and the output from the low-pass filter 4 is input to the sub-sampling unit 5. The sub-sampling unit 5 thins the output of the low-pass filter 4 with the sub-sampling clock so that the subsequent data processing can be performed with the sub-sampling clock.

The output from the sub-sampling unit 5 is input to the gain unit 6. The gain unit 6 adjusts the loop gain of the threshold control loop comprising the comparator 1, the sampling unit 2, the ratio converter 3, the low-pass filter 4, the sub-sampling unit 5, the gain unit 6, the integrator 7, and the threshold DAC 8.

The output from the gain unit 6 is input to the integrator 7. The integrator 7 performs integration of the output from the ratio converter 3 together with the low-pass filter 4, and the output from the integrator 7 is stabilized when the occurrence frequencies of +1 and −1 become equal to each other when the ratio converter 3 is set at (+1,−1). The output value of the integrator is increased with an increase in the occurrence frequency of +1, and it is decreased with an increase in the occurrence frequency of −1.

The output from the integrator 7 is input to the threshold DAC 8. Since the threshold DAC 8 is driven by the output of the integrator 7, the above-described state where the occurrence frequencies of +1 and −1 become equal to each other means that the duty of the binarization result due to the threshold value at this time is 50%. With this threshold value being a boundary, the duty is decreased with an increase in the threshold value, and increased with a decrease in the threshold value. Thereby, the output of the integrator 7 is decreased with an increase in the threshold value, and increased with a decrease in the threshold value, and the feedback system goes into the negative feedback state when the output of the integrator 7 is input to the threshold DAC 8, and thus the position where the duty is 50% is stable.

The gate signal may be made effective at the timing when the space portion being recorded in the optical disc, i.e., the laser power, is at the bias level.

By setting the ratio converter 3 at (+1,−1), the average value of the disc reproduction signal can be measured with the bias power which is close to the laser power during reproduction and is less varied by the linear velocity, and for example, it is effective for detection of a servo error signal during recording in a CAV mode having different linear velocities between the inner circumference and the outer circumference of the optical disc.

Further, the gate signal may be made effective in the second half of the mark portion during recording in a DVD-R, DVD+R, or CD-R disk.

By setting the ratio converter 3 at (+1,−1), the average value of the signal for monitoring the state of recording in a DVD-R, DVD+R, or CD-R disc can be obtained, and thereby recording of the original data can be realized by continually controlling the laser power while performing OPC (Optimum Power Control), i.e., while monitoring the state of the recording surface which is irradiated with weak laser.

As described above, according to the third embodiment, the input signal as a detection target is binarized, the main clock supplied from the clock source is turned on and off by the switch to generate the sampling clock, and the binarized signal is subjected to sampling, ratio conversion, and extraction of low-frequency component by the sampling unit, the ratio converter, and the low-pass filter which are operated with the sampling clock, respectively, and thereafter, the extracted low-frequency component signal is subjected to sub-sampling, adjustment of loop gain, and integration by the sub-sampling unit, the gain unit, and the integrator which are operated by the sub-sampling signal, respectively, thereby to perform peak detection or bottom detection, and further, this integration result is DA-converted to be used as a threshold value for binarization. Therefore, it is possible to reduce the scale of the analog circuit including the parts which are externally attached or occupy a large space in an LSI when large-scale integration is performed, and obtain a digital detection output directly from the signal corresponding to only the ID region in the analog RF signal without using a high-speed and large-scale AD converter.

### Embodiment 4

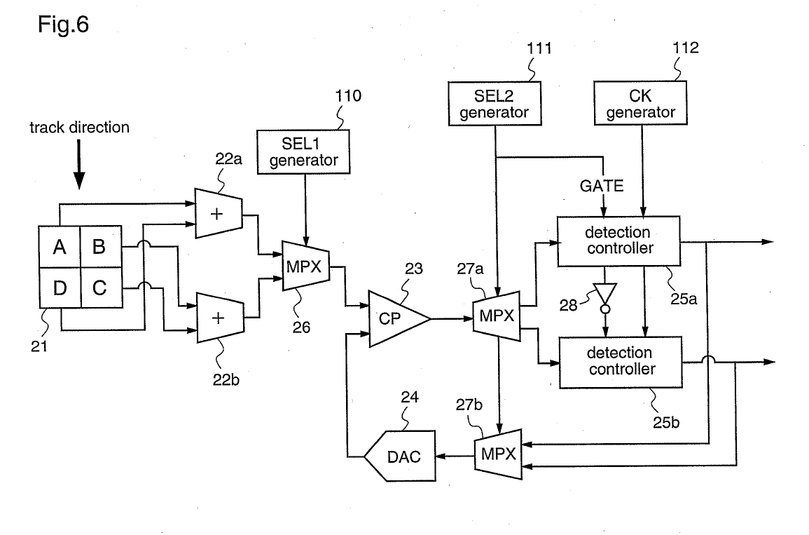

FIG. 6 is a block diagram illustrating an optical disc recording/reproduction apparatus according to a fourth embodiment of the present invention. In this fourth embodiment, a set of a comparator and a threshold DAC are time-divisionally shared for the inner circumference side RF signal and the outer circumference side RF signal to perform detection operation.

In FIG. 6, reference numeral 21 denotes a light-receiving element divided into four parts, which receives reflected light from the optical disc, reference numeral 22a denotes an adder which calculates a sum of signals received by the light-receiving elements A and D placed on the inner circumference side of the disc to generate an inner circumference RF signal, reference numeral 22b denotes an adder which calculates a sum of signals received by the light-receiving elements B and C placed on the outer circumference side of the disc to generate an outer circumference RF signal, reference numeral 26 denotes a selector which selects either of the inner circumference RF signal from the adder 22a or the outer circumference RF signal from the adder 22b according to a first selection signal SEL1 and outputs the selected signal, reference numeral 23 denotes a comparator which compares the output from the selector 26 with a threshold value outputted from a threshold DAC 24, reference numeral 24 denotes a threshold DAC 24 which sets the threshold value for the comparator 23, reference numeral 27a denotes a distributor which distributes the output of the comparator 23 to a first detection controller 25a or a second detection controller 25b according to a selection signal SEL2, reference numerals 25a and 25b denote first and second detection controllers which detect the output of the comparator 23 that is distributed by the distributor 27a, and reference numeral 27b denotes a selector which transfers the output of the first detection controller 25a or the output of the second detection controller 25b to the threshold value DAC 24 according to the second selection signal SEL2. Further, reference numeral 28 denotes an inverter which inverts the second selection signal SEL2 which is a control signal of the detection controller 25a to output the same as a control signal of the detection controller 25b.

Each of the first and second detection controllers 25a and 25b comprises the sampling unit 2, the ratio converter 3, the low-pass filter 4, the sub-sampling unit 5, the gain unit 6, the integrator 7, the frequency divider 10, and the switch 11 shown in FIG. 5. The second selection signal itself is input as a gate signal GATE to the first detection controller 25a while the inverted second selection signal is input as a gate signal to the second detection controller 25b.

Further, reference numeral 110 denotes a first selection signal generator which generates the first selection signal SEL1, reference numeral 111 denotes a second selection signal generator which generates the second selection signal SEL2, and the reference numeral 112 denotes a clock generator which generates a clock signal to be used for the detection controllers 25a and 25b.

Next, the operation will be described.

The adder 22a outputs the inner circumference RF signal which is the sum of the outputs from the light-receiving elements A and D placed at the inner circumference side of the optical disc, and the adder 22b outputs the outer circumference RF signal which is the sum of the outputs from the light-receiving elements B and C placed at the outer circumference side of the optical disc. The selector 26 selects and outputs the inner circumference RF signal outputted from the adder 22a when the first selection signal SEL1 is “H”, and conversely, it outputs the outer circumference RF signal outputted from the adder 22b when it is “L”.

When the second selection signal SEL2 is “H”, the distributor 27a transfers the binarized output of the comparator 23 to the first detection controller 25a, the first detection controller 25a performs detection because the gate signal GATE becomes effective, and the output from the first detection controller 25a is transferred to the threshold DAC 24 by the selector 27b. When the second selection signal is “L”, the second detection controller 25b performs detection, and the output from the second detection controller 25b is transferred to the threshold DAC 24 by the selector 27b.

For example, when the state where the first selection signal SEL1 and the second selection signal SEL2 are both “H” and the state where these signals are both “L” are periodically alternated, the inner circumference RF signal is detected by the first detection controller 25a when the first and second selection signals are both “H” while the outer circumference RF signal is detected by the detection controller 25b when the first and second selection signals are both “L”. Therefore, by setting the switching cycle between the selection signal SEL1 and the selection signal SEL2 to a sufficiently short period, detections of the inner circumference RF signal and the outer circumference RF signal can be performed pseudo-synchronously by using one set of the comparator 23 and the threshold DAC 24.

As described above, according to the fourth embodiment, the inner circumference RF signal and the outer circumference RF signal which are obtained from the light-receiving element are multiplexed and transferred to the comparator, and then these signals are demultiplexed and detected by the first and second detection controllers which are provided in a stage subsequent to the comparator, respectively, and further, the detection results are multiplexed and DA converted to be used as a threshold value for the comparator. Therefore, detections of the inner circumference RF signal and the outer circumference RF signal can be pseudo-synchronously performed.

### Embodiment 5

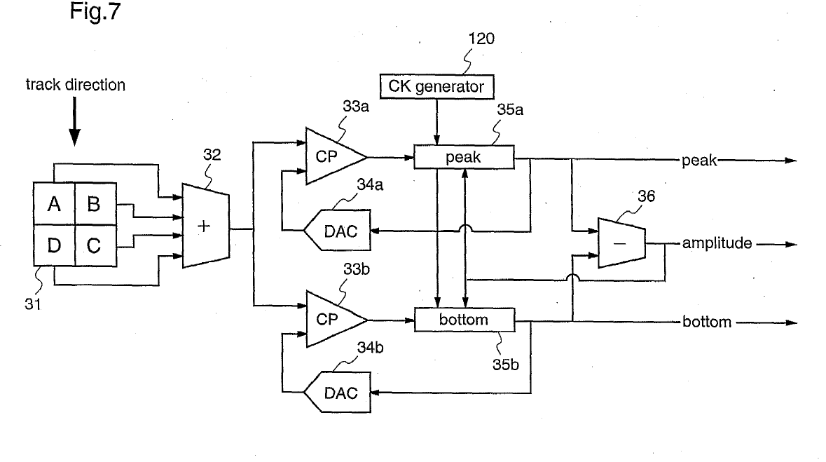

FIG. 7 is a block diagram of an optical disc recording/reproduction apparatus according to a fifth embodiment of the present invention.

In FIG. 7, reference numeral 31 denotes a light-receiving element divided into four parts, which receives reflected light from an optical disc, reference numeral 32 denotes an adder which calculates a sum of the outputs from the four light-receiving elements A, B, C and D into which the light-receiving element 31 is divided, thereby to output an RF signal, reference numeral 33a denotes a first comparator to which the RF signal from the adder 32 is input, reference numeral 34a denotes a first threshold DAC which sets a threshold value for the first comparator 33a, reference numeral 35a denotes a peak detection controller which performs peak detection for the output from the first comparator 33a, reference numeral 33b denotes a second comparator to which the RF signal from the adder 32 is input, reference numeral 34b denotes a second threshold DAC which sets a threshold value for the second comparator 33b, reference numeral 35b denotes a bottom detection controller which performs bottom detection for the output from the second comparator 33b, and reference numeral 36 denotes a subtracter which calculates a difference between the output of the peak detection controller 35a and the output of the bottom detection controller 35b to output an amplitude signal, and this amplitude signal is outputted also to the peak detector 35a and the bottom detector 35b as a control signal.

Each of the peak detection controller 35a and the bottom detection controller 35b comprises the sampling unit 2, the ratio converter 3, the low-pass filter 4, the sub-sampling unit 5, the gain unit 6, and the integrator 7 which are shown in FIG. 1, and the ratio converter in the peak detection controller 35a is set at (+15,−1) while the ratio converter in the bottom detection controller 35b is set at (+1,−15), and the output of the subtracter 36 is connected to the gain units of the peak detection controller 35a and the bottom detection controller 35b.

Further, reference numeral 120 denotes a clock generator which generates a clock signal CK to be used by the peak detection controller 35a and the bottom detection controller 35b.

Next, the operation will be described. The outputs from the four light-receiving elements A, B, C and D into which the light-receiving element 31 is divided are added to each other by the adder 32 to be an RF signal, this RF signal is compared with the threshold values outputted from the threshold DACs 34a and 34b by the comparators 33a and 33b to be binarized, respectively, and the binarized outputs from the comparators 33a and 33b are subjected to peak detection and bottom detection by the peak detector 35a and the bottom detector 35b, respectively. Further, the outputs from the peak detector 35a and the bottom detector 35b are subjected to subtraction by the subtracter 36 to obtain an amplitude signal, and this amplitude signal controls the gains of the gain units in the peak detector 35a and the bottom detector 35b, respectively.

By the way, when performing feedback using the comparator and the threshold DAC so as to make the duty of the binarized signal have a specific value, the transfer gain from the change in the threshold value to the change in the duty of the binarized signal depends on the amplitude of the signal to be the detection target, and the transfer gain is increased as the signal amplitude is decreased. Therefore, in the case where the amplitude of the reproduced RF signal is temporarily decreased or becomes almost zero due to a failure which reduces the reflected light amount during the optical disc reproduction, the feedback loop might be oscillated at this portion.

So, when peak detection and bottom detection for the RF signal are simultaneously performed, for example, when drop-out detection and off-track detection are performed, such oscillation can be avoided by generating an amplitude signal to perform gain switching between the peak detection controller and the bottom detection controller.

To be specific, the amplitude signal is normalized such that an amplitude signal having a normal RF signal amplitude becomes 1, and the values set in the gain units of the peak detection controller 35a and the bottom detection controller 35b are multiplied by the value of this amplitude signal and the obtained results are used as the gains, and thereby the feedback gains in proportion to the amplitude signal can be set.

When no multiplier is used, several levels of gains are previously set according to the value of the amplitude signal, and the gains may be switched according to the value of the amplitude signal.

As described above, according to the fifth embodiment, all the outputs from the divided four light-receiving elements are added to each other to generate an RF signal, and the RF signal is subjected to peak detection and bottom detection, and further, the gains of the peak detection controller and the bottom detection controller are switched according to a difference between the peak detection output and the bottom detection output. Therefore, it is possible to avoid occurrence of oscillation even when the optical disc has a failure.

### Embodiment 6

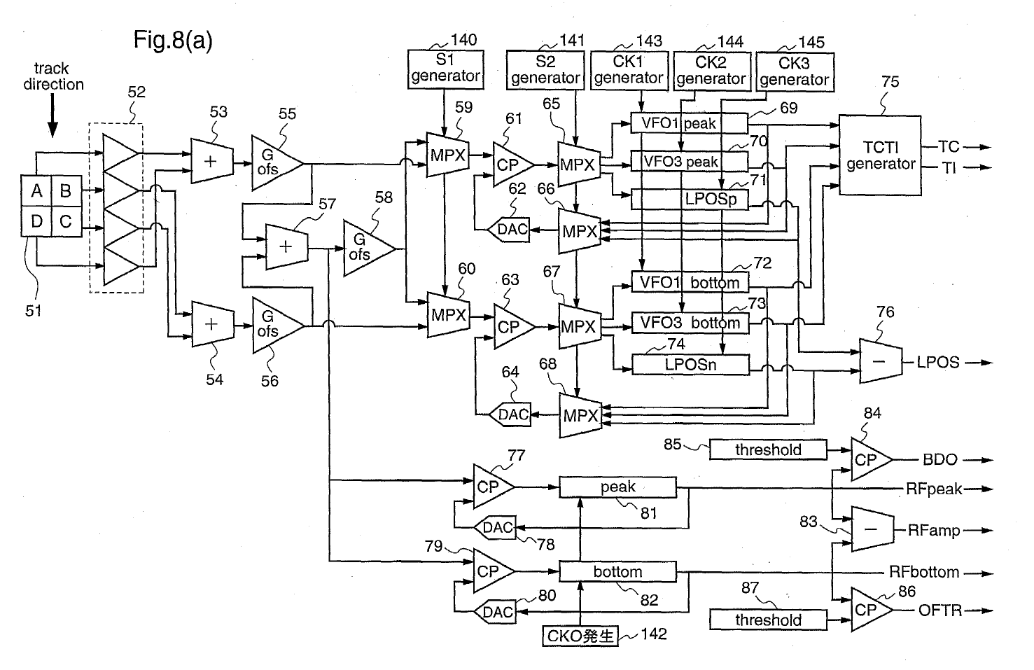

FIG. 8(a) is a block diagram of an optical disc recording/reproduction apparatus according to a sixth embodiment of the present invention.

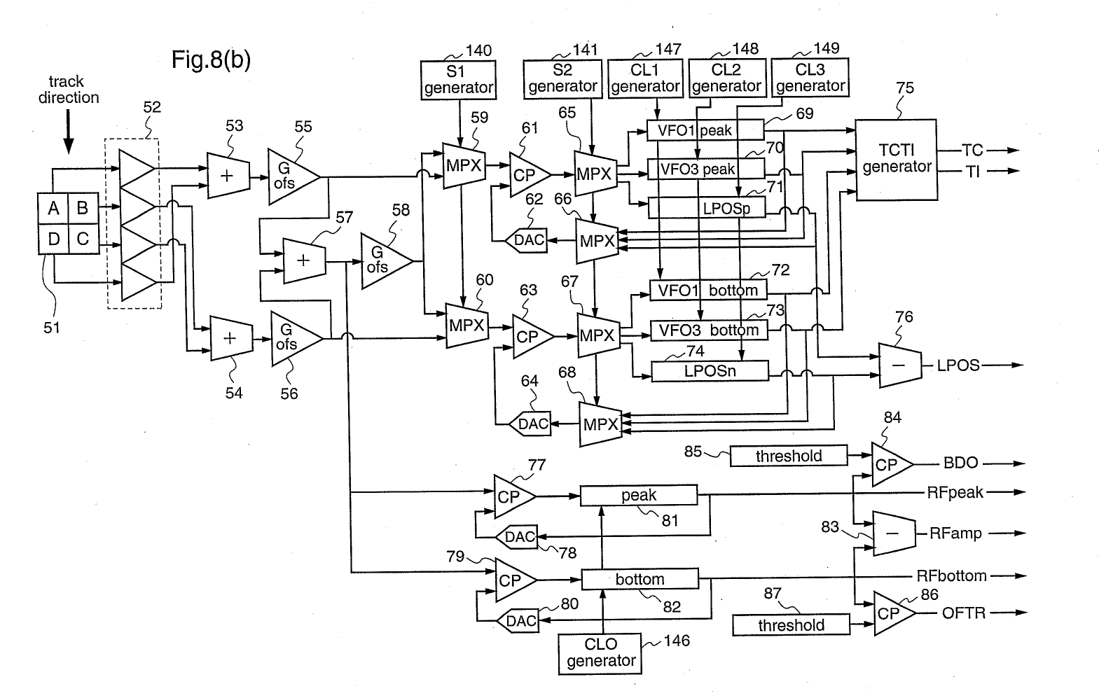

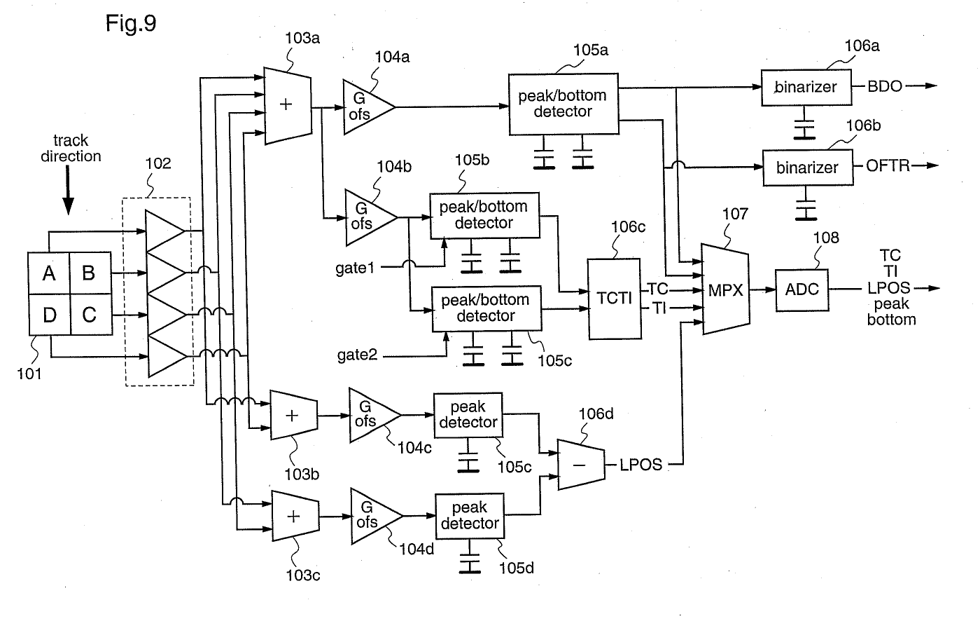

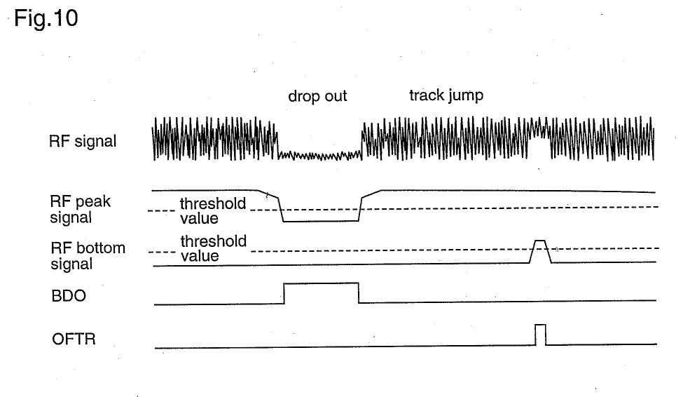

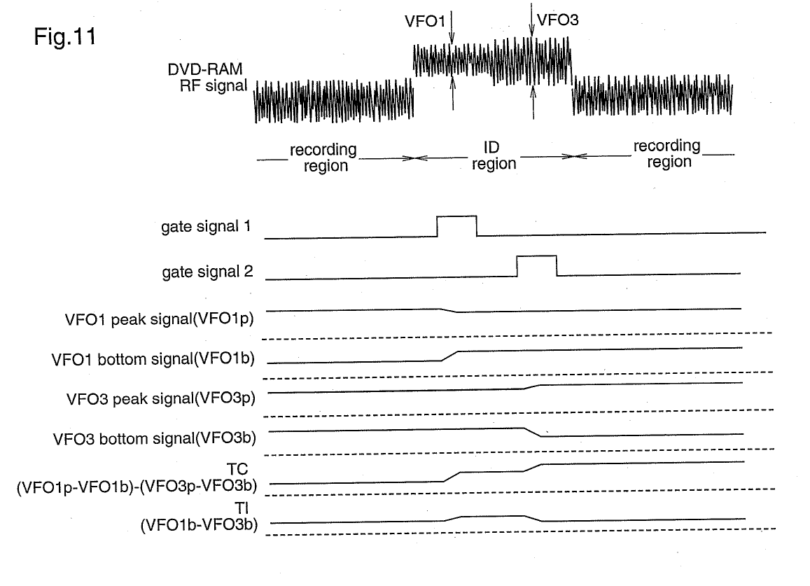

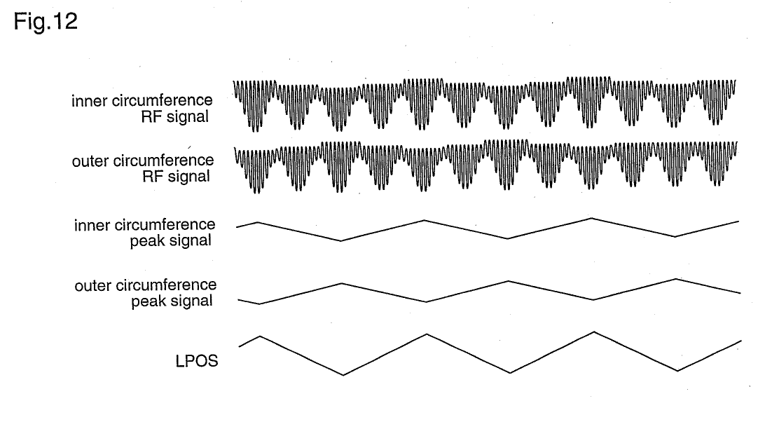

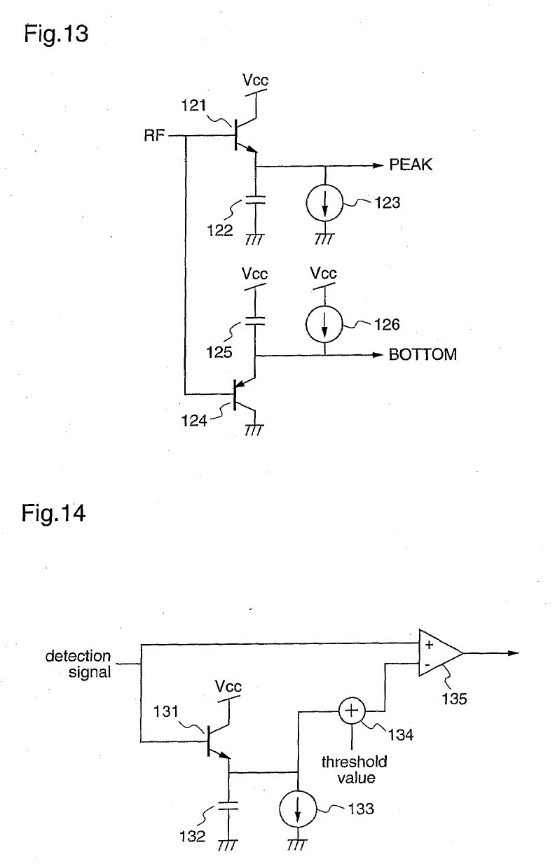

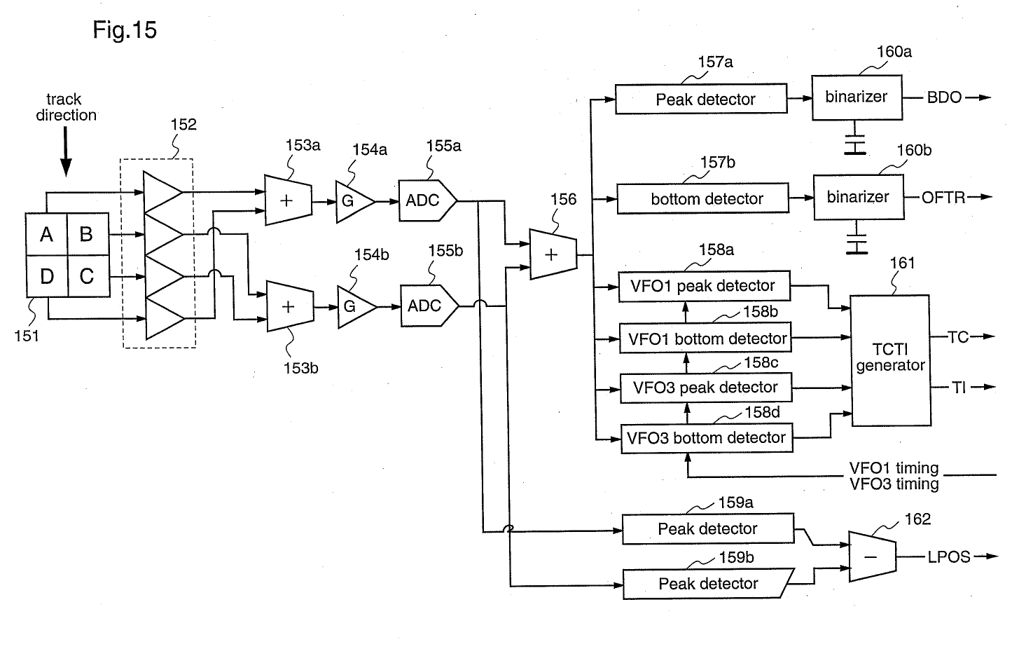

In this sixth embodiment, signals such as TC, TI, BDO, and LPOS can be obtained by performing peak/bottom detection as described for the first prior art shown in FIG. 9 and the second prior art shown in FIG. 15, and moreover, a high-speed AD converter can be dispensed with while reducing the analog circuits, and the detection result can be obtained not stochastically.

In FIG. 8(a), reference numeral 51 denotes a light-receiving element divided into four parts, which receives reflected light from an optical disc, and reference numeral 52 denotes an amplifier comprising four IV conversion amplifiers which IV-convert the output signals from the four light-receiving elements A, B, C and D into which the light-receiving element 151 is divided. Reference numeral 53 denotes an adder which calculates a sum of the detection signals from the inner circumference side light-receiving elements A and D of the light-receiving element 51, reference numeral 54 denotes an adder which calculates a sum of the detection signals from the outer circumference side light-receiving elements B and C of the light-receiving element 51, reference numeral 55 denotes an amplifier which appropriately adjusts the dynamic range of the output signal from the adder 53 to output the same as an inner circumference RF signal, reference numeral 56 denotes an amplifier which appropriately adjusts the dynamic range of the output signal from the adder 54 to output the same as an outer circumference RF signal, reference numeral 57 denotes an adder which calculates a sum of the inner circumference RF signal and the outer circumference RF signal to output the same as an addition RF signal, reference numeral 58 denotes an amplifier which appropriately adjusts the dynamic range of the signal in the ID region in the addition RF signal during DVD-RAM playback to output the same as an IDRF signal, reference numeral 59 denotes a selector which selects and outputs either of the inner circumference RF signal or the IDRF signal according to a first selection signal S1, and reference numeral 60 denotes a selector which selects and outputs either of the outer circumference RF signal or the IDRF signal according to the first selection signal S1.

Further, reference numeral 61 denotes a comparator which receives the output of the selector 59, reference numeral 65 denotes a distributor which distributes the binarized output of the comparator 61 to any of a VFO1 peak detection controller 69, a VFO3 peak detection controller 70, and a LPOSp detection controller 71 according to a second selection signal S2, reference numeral 69 denotes a VFO1 peak detection controller which is operated by a first sampling clock CK1 to perform peak detection for the output of the distributor 65, reference numeral 70 denotes a VFO3 peak detection controller which is operated by a second sampling clock CK2 to perform peak detection for the output of the distributor 65, reference numeral 71 denotes a LPOSp detection controller which is operated by a third sampling clock CK3 to detect the output of the distributor 65, reference numeral 66 denotes a selector which selects any of the output from the VFO1 peak detection controller 69, the output from the VFO3 peak detection controller 70, and the output from the LPOSp detection controller 71 according to the second selection signal S2 and outputs the selected signal to a threshold DAC 62, and reference numeral 62 denotes a threshold DAC which DA-converts the output from the selector 66 to set a threshold value of the comparator 61.

Further, reference numeral 63 denotes a comparator which receives the output from the selector 60, reference numeral 67 denotes a distributor which distributes the binarized output of the comparator 63 to any of a VFO1 bottom detection controller 72, a VFO3 bottom detection controller 73, and a LPOSn detection controller 74 according to the second selection signal S2, reference numeral 72 denotes a VFO1 bottom detection controller which is operated by the first sampling clock CK1 to perform bottom detection for the output of the distributor 67, reference numeral 73 denotes a VFO3 bottom detection controller which is operated by the second sampling clock CK2 to perform bottom detection for the output of the distributor 67, reference numeral 74 denotes a LPOSp detection controller which is operated by the third sampling clock to detect the output of the distributor 67, reference numeral 68 denotes a selector which selects any of the output from the VFO1 bottom detection controller 72, the output from the VFO3 bottom detection controller 73, and the output from the LPOSn detection controller 74 according to the second selection signal S2 and outputs the selected signal to a threshold DAC 64, and reference numeral 64 denotes a threshold DAC which DA-converts the output of the selector 68 to set a threshold value of the comparator 63.

Further, reference numeral 75 denotes a TCTI generator which generate a track center signal (TC) and a tilt signal (TI) according to the output of the VFO1 peak detection controller 69, the output of the VFO3 peak detection controller 70, the output of the VFO1 bottom detection controller 72, and the output of the VFO3 bottom detection controller 73, and reference numeral 76 denotes a subtracter which calculates a difference between the output of the LPOSp detection controller 71 and the output of the LPOSn detection controller 74 to generate a lens position signal (LPOS).

Further, reference numeral 77 denotes a comparator which receives the addition RF signal from the adder 57, reference numeral 81 denotes a peak detection controller which performs peak detection upon receipt of the binarized signal from the comparator 77, reference numeral 78 denotes a threshold DAC which DA-converts the output of the peak detection controller 81 to set a threshold value of the comparator 77, reference numeral 79 denotes a comparator which receives the addition RF signal from the adder 57, reference numeral 82 denotes a bottom detection controller which performs bottom detection upon receipt of the binarized signal from the comparator 79, reference numeral 80 denotes a threshold DAC which DA-converts the output of the bottom detection controller 82 to set a threshold value of the comparator 79, reference numeral 84 denotes a comparator which receives the output of the peak detection controller 81 and outputs a BDO signal, reference numeral 85 denotes a threshold setting unit which sets a threshold value of the comparator 84, reference numeral 86 denotes a comparator which receives the output of the bottom detection controller 82 and outputs an OFTR signal, reference numeral 87 denotes a threshold setting unit which sets a threshold value of the comparator 86, and reference numeral 83 denotes a subtracter which calculates a difference between the output of the peak detection controller 81 and the output of the bottom detection controller 82 to output an RF amplitude signal.

Reference numeral 140 denotes a first selection signal generator which generates the first selection signal S1, and the first selection signal S1 is operated so as to select the IDRF signal in the ID region when performing DVD-RAM playback, while in other cases it is operated such that the selectors 59 and 60 select the inner circumference RF signal and the outer circumference RF signal, respectively. Further, reference numeral 141 denotes a second selection signal generator which generates the second selection signal S2.

Further, reference numeral 143 denotes a first sampling clock generator which generates the first sampling clock CK1, and the first sampling clock CK1 is effective in the region of VFO1 during DVD-RAM playback. Reference numeral 144 denotes a second sampling clock generator which generates the second sampling clock CK2, and the second sampling clock CK2 also becomes effective in the region of VFO3 during DVD-RAM playback. Reference numeral 145 denotes a third sampling clock generator which generates the third sampling clock CK3, and this third sampling clock CK3 is effective during seek operation of the optical disc recording/reproduction apparatus. The frequencies of the first to third sampling clocks are approximately equal to the bit rate of the reproduction RF signal.

Reference numeral 142 denotes a fourth sampling clock generator which generate a fourth sampling clock CK0. This sampling clock CK0 is a clock having a continuous frequency which is approximately equal to the bit rate of the reproduction RF signal, and it is used in the peak detection controller 81 and the bottom detection controller 82.

Next, the operation will be described. The reflected light from the optical disc is light-to-electricity converted by the light-receiving element 51, the signals from the divided four light receiving elements A, B, C and D are IV-converted by the amplifier 52, and a sum of signals obtained by amplifying the output signals from the inner circumference light-receiving elements A and D is calculated by the adder 53. Further, a sum of signals obtained by amplifying the output signals from the outer circumference light-receiving elements B and C is calculated by the adder 54. The output signal from the adder 53 is adjusted by the amplifier 55 so as to have an appropriate dynamic range, and outputted as an inner circumference RF signal. The dynamic range of the output signal from the adder 54 is appropriately adjusted by the amplifier 55 to be outputted as an outer circumference RF signal. The inner circumference RF signal and the outer circumference RF signal are added to each other by the adder 57 to be an addition RF signal, and the dynamic range of the addition RF signal is appropriately adjusted by the amplifier 58 to be outputted as an IDRF signal. The selectors 59 and 60 perform selection operations according to the first selection signal S1. To be specific, the selector 59 selects the IDRF signal outputted from the amplifier 58 in the ID region during DVD-RAM playback, while in other cases it selects the inner circumference RF signal outputted from the amplifier 55. Further, the selector 60 selects the IDRF signal outputted from the amplifier 58 in the ID region during DVD-RAM playback, while in other cases it selects the outer circumference RF signal outputted from the amplifier 56.

The output signals from the selectors 59 and 60 are compared by the comparators 61 and 63 with the output signals from the DACs 62 and 64 which are the threshold values for these comparators, respectively, and binarized. The distributors 65 and 67 perform selection operations according to the second selection signal S2, and the output signal from the comparator 61 is distributed to the VFO1 peak detection controller 69 in the region of VFO1 during DVD-RAM playback, to the VFO3 peak detection controller 70 in the region of VFO3 during DVD-RAM playback, and to the LPOSp detection controller 71 during the seek operation of the optical disc recording/reproduction apparatus, and thereby peak detection is performed by the VFO1 peak detection controller 69 and the VFO3 peak detection controller 70 while LPOSp detection is performed by the LPOSp detection controller 71. Further, the output signal from the comparator 63 is distributed to the VFO1 bottom detection controller 72 in the region of VFO1 during DVD-RAM playback, to the VFO3 bottom detection controller 73 in the region of VFO3 during DVD-RAM playback, and to the LPOSn detection controller 74 during the seek operation of the optical disc recording/reproduction apparatus, and thereby bottom detection is performed by the VFO1 bottom detection controller 72 and the VFO3 bottom detection controller 73 while LPOSn detection is performed by the LPOSn detection controller 74.

Then, a TC signal and a TI signal are generated by the TCTI generator 75 using the peak detection output from the VFO1 peak detection controller 69, the peak detection output from the VFO3 peak detection controller 70, the bottom detection output from the VFO1 bottom detection controller 72, and the bottom detection output from the VFO3 bottom detection controller 73. Further, a difference between the output signal from the LPOSp detection controller 71 and the output signal from the LPOSn detection controller 74 is calculated by the subtracter 76, and thereby an LPOS signal is generated.

The output of the VFO1 peak detection controller 69, the output of the VFO3 peak detection controller 70, and the output of the LPOSp detection controller 71 are selected by the selector 66 according to the second selection signal S2, and outputted to the DAC 62 to be the threshold value for the comparator 61.

Further, one of the output of the VFO1 bottom detection controller 72, the output of the VFO3 bottom detection controller 73, and the output of the LPOSn detection controller 74 is selected by the selector 68 according to the second selection signal S2, and outputted to the DAC 64 to be the threshold value for the comparator 63.

Furthermore, the output signal from the adder 57 is compared with the threshold values outputted from the DACs 78 and 80 by the comparators 77 and 79, respectively, and binarized. The output signal from the comparator 77 is subjected to peak detection by the peak detection controller 81 to obtain an RF peak signal, while the output signal from the comparator 79 is subjected to bottom detection by the bottom detection controller 82 to obtain an RF bottom signal. The output signal from the peak detection controller 81 is converted into an analog signal by the DAC 78 to be used as a threshold value for the comparator 77. Likewise, the output signal from the bottom detection controller 82 is converted into an analog signal by the DAC 80 to be used as a threshold value for the comparator 79.

The output signal from the peak detection controller 81 is compared by the comparator 84 with the threshold value that is set by the threshold setting unit 85, and a BDO signal is obtained as a comparison result. Further, the output signal from the bottom detection controller 82 is compared by the comparator 86 with the threshold value set by the threshold setting unit 87, and an OFTR signal is obtained as a comparison result.

Further, a difference between the output signal of the peak detection controller 81 and the output signal of the bottom detection controller 82 is calculated by the subtracter 83, thereby to obtain an RF amplitude signal.

Through the above-described operations, a peak envelope and a bottom envelope of VFO1 and VFO3 are measured in the CAPA region during DVD-RAM recording/playback, and a track center signal (TC) and a tilt signal (TI) are detected from the result of the measurement. Further, peak envelopes of the inner circumference RF signal and the outer circumference RF signal are measured during seeking, and a lens position signal (LPOS) can be obtained by calculating a difference between the peak envelopes. Further, a peak envelope and a bottom envelope of the addition RF signal are measured, and a BDO signal and an OFTR signal can be obtained by binarizing the changes in the envelopes.

While in this sixth embodiment there are timings when no detection operation is carried out, such as reproduction of other than DVD-RAM and recording/reproduction of the data region of DVD-RAM, as the operation modes of the optical disc recording/reproduction apparatus, more processes may be added at these timings. For example, an AGC process of measuring the amplitudes and offsets of the inner circumference RF signal and the outer circumference RF signal to make them constant can be realized without adding a comparator and a threshold DAC.

Further, while in this sixth embodiment the operations of the respective controllers 69 to 73, 81, and 82 are switched according to ON/OFF of the clocks, this switching may be performed not by the clocks but by control signals as shown in FIG. 8(b).

To be specific, as shown in FIG. 8(b), the VFO1 peak detection controller 69 and the VFO1 bottom detection controller 72 are operated by a first control signal CL1, the VFO3 peak detection controller 70 and the VFO3 bottom detection controller 73 are operated by a second control signal CL2, and the LPOSp detection controller 71 and the LPOSn detection controller 74 are operated by a third control signal CL3.

Reference numeral 147 denotes a first control signal generator for generating the first control signal CL1, reference numeral 148 denotes a second control signal generator for generating the second control signal CL2, and reference numeral 149 denotes a third control signal generator for generating the third control signal CL3.

While the first to sixth embodiments are applied to the optical disc recording/reproduction apparatus, these embodiments may be applied to an optical disc reproduction apparatus.

While in the first to sixth embodiments the clocks, the selection signals, the control signals, and the gate signals are generated by using the different circuits for the respective signals, these signals may be generated by a single circuit.

As described above, according to the sixth embodiment, detections of a TCTI signal and an LPOS signal can be performed by obtaining six kinds of detection results using two sets of comparators and threshold DACs, and moreover, the respective signal detections can be carried out completely independently without mutual interference by switching the detection signals according to the operation mode of the optical disc recording/reproduction apparatus. This is an effect obtained by realizing a function that the respective detection controllers are configured by digital circuits, the previous state is completely held while the detection circuit operation is halted, and the detection circuit operates as if there existed no halt period when it is operated.

### APPLICABILITY IN INDUSTRY

As described above, since the optical disc recording/reproduction apparatus of the present invention can simplify the configuration of the analog circuit, it is effective to such as reduction in chip size by micro processing. Further, since the apparatus can facilitate tuning of such as anti-noise property or followability, it is also effective as a technique for promoting streamlining of optical disc recording/reproduction apparatuses.

1. An optical disc recording/reproduction apparatus comprising:
a comparator to which a signal as a detection target is inputted;
a digital-to-analog converter for threshold generation (hereinafter referred to as a threshold DAC) which generates a signal to be used as a threshold value when the comparator performs a comparison operation; and
a detection controller which controls the threshold value of the threshold DAC upon receipt of the output from the comparator;
said detection controller including
a sampling unit which samples the output of the comparator with a sampling clock,
a ratio converter which converts the binary output of the sampling unit into two constant values which are positive and negative,
a low-pass filter which removes a high-frequency component from the output of the ratio converter,
a sub-sampling unit which samples the output of the low-pass filter with a sub-sampling clock having a frequency equal to or smaller than that of the sampling clock,
a gain unit which multiplies the output of the sub-sampling unit by a set gain, and
an integrator which integrates the output of the gain unit and outputs the result to the threshold DAC.

2. An optical disc recording/reproduction apparatus as defined in claim 1 wherein
said detection controller further includes an edge extension unit which extends an H period or L period of the output from the sampling unit by an approximately constant time, said edge extension unit being placed between the sampling unit and the ratio converter.

3. An optical disc recording/reproduction apparatus as defined in claim 1 wherein
said detection controller further includes an edge extension unit which extends an H period or L period of the output from the comparator by an approximately constant time, said edge extension unit being placed in a stage prior to the sampling unit.

4. An optical disc recording/reproduction apparatus as defined in claim 2 wherein
said edge extension unit prevents the H period or L period of the output from the comparator from becoming equal to or shorter than the constant time.

5. An optical disc recording/reproduction apparatus as defined in claim 2 wherein
said extension time is approximately equal to a maximum appearance cycle or an average appearance cycle of a peak level or a bottom level of the input signal.

6. An optical disc recording/reproduction apparatus as defined in claim 2 wherein
said extension time is 1/constant value with respect to a maximum appearance cycle or an average appearance cycle of a peak level or a bottom level of the input signal.

7. An optical disc recording/reproduction apparatus as defined in claim 1 wherein
said sampling clock is controlled to be effective only during the detection period, and
said sub-sampling clock is generated by frequency-dividing the sampling clock.

8. An optical disc recording/reproduction apparatus as defined in claim 1 wherein
said ratio converter outputs “+1/−1” or “+N/−1”, “+1/−N” (N: positive integer) in response to “H/L” of the input logic value.

9. An optical disc recording/reproduction apparatus as defined in claim 1 wherein
said ratio converter outputs “+P/−Q” (P and Q: positive integers) in response to “H/L” of the input logic value.

10. An optical disc recording/reproduction apparatus as defined in claim 1 wherein
said low-pass filter has a cutoff frequency which is equal to or less than ½ of the frequency of the sub-sampling clock.

11. An optical disc recording/reproduction apparatus as defined in claim 1 wherein
said sub-sampling clock has a cycle which is an integer multiple of the sampling clock, and
said low-pass filter calculates a moving total or a moving average of sampling data which are equal in number to the ratio of the cycles of the sub-sampling clock and the sampling clock.

12. An optical disc recording/reproduction apparatus comprising:
single or plural light-receiving elements which receive reflected light of a light beam incident on an optical disc;
a signal generator which generates an RF signal from the outputs of the respective light-receiving elements;
a comparator to which the RF signal is inputted;
a threshold DAC which generates a signal to be used as a threshold value when the comparator performs a comparison operation; and
a detection controller which outputs a threshold value signal to the threshold DAC upon receipt of the output from the comparator, and generates a detection signal;
said detection controller including
a sampling unit which samples the output of the comparator with a sampling clock,
a ratio converter which converts the binary output of the sampling unit into two constant values which are positive and negative,
a low-pass filter which removes a high-frequency component from the output of the ratio converter,
a sub-sampling unit which samples the output of the low-pass filter with a sub-sampling clock having a frequency equal to or smaller than that of the sampling clock,
a gain unit which multiplies the output of the sub-sampling unit by a set gain, and
an integrator which integrates the output of the gain unit and outputs the result to the threshold DAC,
said detection controller being supplied with a sampling clock having a frequency that is set in response to the frequency of the RF signal.

13. An optical disc recording/reproduction apparatus comprising:
a plurality of light-receiving elements which receive reflected light of a light beam incident on an optical disc;
a plurality of signal generators which generate plural RF signals from the outputs of the plural light-receiving elements;
a first selector which receives the plural RF signals, and selects and outputs one of the RF signals according to a first selection signal;
a comparator to which the signal outputted from the first selector is inputted;
a threshold DAC which generates a signal to be used as a threshold value when the comparator performs a comparison operation;
a plurality of detection controllers which generate plural detection signals;
a distributor which distributes the comparison result of the comparator to one of the plural detection controllers that is selected by a second selection signal; and
a second selector which selects one of the threshold value signal outputs from the plural detection controllers, and outputs the selected signal to the threshold DAC;
each of said plural detection controllers including
a sampling unit which samples the output of the comparator with a sampling clock,
a ratio converter which converts the binary output of the sampling unit into two constant values which are positive and negative,
a low-pass filter which removes a high-frequency component from the output of the ratio converter,
a sub-sampling unit which samples the output of the low-pass filter with a sub-sampling clock having a frequency equal to or smaller than that of the sampling clock,
a gain unit which multiplies the output of the sub-sampling unit by a set gain, and
an integrator which integrates the output of the gain unit and outputs the result to the threshold DAC,
said plural detection controllers being operated by plural sampling clocks applied thereto, and each of the sampling clocks having a frequency that is set in response to the frequency of the RF signal, and becoming effective only when the corresponding detection controller is selected by the second selection signal.

14. An optical disc recording/reproduction apparatus comprising:
single or plural light-receiving elements which receive reflected light of a light beam incident on an optical disc;
a signal generator which generates an RF signal from the outputs of the respective light-receiving elements;
a first comparator to which the RF signal is inputted;
a first threshold DAC which generates a signal to be used as a threshold value when the first comparator performs a comparison operation;
a peak detection controller which outputs a threshold value signal to the first threshold DAC upon receipt of the output from the first comparator, and generates a peak detection signal;
a second comparator to which the RF signal is inputted;
a second threshold DAC which generates a signal to be used when the second comparator performs a comparison operation; and
a bottom detection controller which outputs a threshold value signal to the second threshold DAC upon receipt of the output from the second comparator, and generates a bottom detection signal;
each of the peak detection controller and the bottom detection controller including
a sampling unit which samples the output of the comparator with a sampling clock,
a ratio converter which converts the binary output of the sampling unit into two constant values which are positive and negative,
a low-pass filter which removes a high-frequency component from the output of the ratio converter,
a sub-sampling unit which samples the output of the low-pass filter with a sub-sampling clock having a frequency equal to or smaller than that of the sampling clock,
a gain unit which multiplies the output of the sub-sampling unit by a set gain, and
an integrator which integrates the output of the gain unit and outputs the result to the threshold DAC,
said peak detection controller and said bottom detection controller being supplied with sampling clocks having frequencies that are set in response to the frequency of the RF signal.

15. An optical disc recording/reproduction apparatus as defined in claim 14 further including
a subtracter which calculates a difference between the output of the peak detection controller and the output of the bottom detection controller to generate an amplitude signal, and
said peak detection controller and said bottom detection controller change the control parameters according to the amplitude signal.

16. An optical disc recording/reproduction apparatus as defined in claim 15 wherein
said control parameter is an amplification factor used when the detection controller generates a threshold value signal to be outputted to the threshold DAC.

17. An optical disc recording/reproduction apparatus comprising:
a plurality of light-receiving elements which receive reflected light of a light beam incident on an optical disc;
a plurality of signal generators which generate plural RF signals from the outputs of the plural light-receiving elements;
a first selector which receives the plural RF signals, and selects and outputs one of the RF signals according to a first selection signal;
first and second comparators to which the signal outputted from the first selector is inputted;
first and second threshold DACs which generate signals to be used as threshold values when the first and second comparators perform comparison operations, respectively;
a plurality of peak detection controllers which generate plural peak detection signals;
a plurality of bottom detection controllers which generate plural bottom detection signals;
a first distributor which distributes the comparison result of the first comparator to one of the plural peak detection controllers which is selected by the second selection signal;
a second distributor which distributes the comparison result of the second comparator to one of the plural bottom detection controllers which is selected by the second selection signal;
a second selector which selects one of the threshold value signal outputs of the plural peak detection controllers according to the second selection signal, and inputs the selected signal to the first threshold DAC; and
a third selector which selects one of the threshold value signal outputs from the plural bottom detection controllers according to the second selection signal, and outputs the selected signal to the second threshold DAC; and
each of the plural peak detection controllers and the plural bottom detection controllers including
a sampling unit which samples the output of the comparator with a sampling clock,
a ratio converter which converts the binary output of the sampling unit into two constant values which are positive and negative,
a low-pass filter which removes a high-frequency component from the output of the ratio converter,
a sub-sampling unit which samples the output of the low-pass filter with a sub-sampling clock having a frequency equal to or smaller than that of the sampling clock,
a gain unit which multiplies the output of the sub-sampling unit by a set gain, and
an integrator which integrates the output of the gain unit and outputs the result to the threshold DAC,
said peak detection controllers and said bottom detection controllers being operated with plural sampling clocks applied thereto, and each of the sampling clocks having a frequency that is set in response to the frequency of the RF signal, and becoming effective only when the corresponding detection controller is selected by the second selection signal.

18. An optical disc recording/reproduction apparatus comprising:
a comparator to which a signal as a detection target is inputted;
a threshold DAC which generates a signal to be used as a threshold value when the comparator performs a comparison operation; and
a detection controller which controls the threshold value of the threshold DAC upon receipt of the output from the comparator;
said detection controller including
a sampling unit which samples the output of the comparator with a sampling clock,
a ratio converter which converts the binary output of the sampling unit into two constant values which are positive and negative, and
an integrator which integrates the output of the ratio converter and outputs the result to the threshold DAC.

19. An optical disc recording/reproduction apparatus comprising:
a comparator to which a signal as a detection target is inputted;
a threshold DAC which generates a signal to be used as a threshold value when the comparator performs a comparison operation; and
a detection controller which controls the threshold value of the threshold DAC upon receipt of the output from the comparator;
said detection controller including
a sampling unit which samples the output of the comparator with a sampling clock,
a ratio converter which converts the binary output of the sampling unit into two constant values which are positive and negative,
a gain unit which multiplies the output of the ratio converter by a set gain, and
an integrator which integrates the output of the gain unit and outputs the result to the threshold DAC.

20. An optical disc recording/reproduction apparatus comprising:
a comparator to which a signal as a detection target is inputted;
a threshold DAC which generates a signal to be used as a threshold value when the comparator performs a comparison operation; and
a detection controller which controls the threshold value of the threshold DAC upon receipt of the output from the comparator;
said detection controller including
a sampling unit which samples the output of the comparator with a sampling clock,
a ratio converter which converts the binary output of the sampling unit into two constant values which are positive and negative,
a low-pass filter which removes a high-frequency component from the output of the ratio converter,
a gain unit which multiplies the output of the low-pass filter by a set gain, and
an integrator which integrates the output of the gain unit and outputs the result to the threshold DAC.

21. An optical disc recording/reproduction apparatus as defined in claim 3 wherein
said edge extension unit prevents the H period or L period of the output from the comparator from becoming equal to or shorter than the constant time.

22. An optical disc recording/reproduction apparatus as defined in claim 3 wherein
said extension time is approximately equal to a maximum appearance cycle or an average appearance cycle of a peak level or a bottom level of the input signal.

23. An optical disc recording/reproduction apparatus as defined in claim 3 wherein
said extension time is 1/constant value with respect to a maximum appearance cycle or an average appearance cycle of a peak level or a bottom level of the input signal.
